(19) United States
(12) Patent Application Publication
(10) Pub. No.: US 2022/0315352 A1
(43) Pub. Date: Oct. 6, 2022

(54) KITTING SHELF MACHINE WITH SELF-LOADING PRESENTATION FACE

(71) Applicant: Dexterity, Inc., Redwood City, CA (US)

(72) Inventors: Zhouwen Sun, Redwood City, CA (US); Robert Holmberg, Mountain View, CA (US); Shitij Kumar, Redwood City, CA (US); Jeesu Baek, San Mateo, CA (US); Joseph Li, San Jose, CA (US); Kishore Ranganath Ramakrishnan, Raleigh, NC (US); Andrew Lovett, San Mateo, CA (US)

(21) Appl. No.: 17/219,503

(22) Filed: Mar. 31, 2021

(51) Int. Cl. B65G 47/90; B65G 47/68; B65G 47/69; B65G 47/88

(52) U.S. Cl. CPC B65G 47/904; B65G 47/681; B65G 47/69; B65G 47/8823; B25J 9/0096

(57) ABSTRACT

A robotic singulation system is disclosed. In various embodiments, sensor data image including data associated with an item present in a workspace in a workspace is received. The sensor data is used to determine and implement a plan to autonomously operate a robotic structure to move and place the item singly in a corresponding location in a singulation conveyance structure. The plan takes into consideration an attribute of the item determined based at least in part on the sensor data.

### BACKGROUND OF THE INVENTION

Robots have been used to perform tasks in manufacturing and other fields. For example, robots have been used to perform tasks in environments that may be unhealthy or otherwise dangerous to humans, tasks that require the application of force greater than a human may be able to apply, and tasks that require a high degree of precision and consistency over time.

Autonomous robots perform at least some tasks in an automated manner, without requiring human control or direction. For example, automated robots have been used to perform repetitive and/or otherwise predetermined tasks and sequences of tasks, typically in a controlled environment, such as a factory. More recently, self-driving cars, delivery drones, and other autonomous vehicles have been under development.

Teleoperation in the field of robotics refers to remote operation of a robot by an operator. For example, robots have been used to perform surgery, defuse bombs, and perform other tasks under the control of a skilled human operator.

Kitting and related processes typically involve gathering and packaging individual items together in a single kit or package. For example, an online or mail order retailer may collect individual items included in an order and package them together in a box or other packaging, which is then addressed and shipped to a destination address associated with the order.

Retailers and other vendors typically stock individual items they offer for sale. Such stock may be maintained in a warehouse or other storage facility. A process to fulfill an order may involve locating and selecting the ordered quantity of each individual item; selecting packaging, such as a box of a size and dimensions to accommodate the collection of items in the order; arranging items in the box or other packaging; addressing and shipping the package; processing a sale transaction; etc.

Kitting may be performed manually. For example, employees may collect items from shelves, bins, or other storage locations, each in a corresponding location within a warehouse or other facility. Aspects of kitting operations have been automated in part, such as box assembly. Use of robots or other machines to perform kitting operations has been proposed and explored, but challenges have been encountered, such as the relative complexity associated with using a robotic arm to find arbitrary quantities of an arbitrary set of items, and providing and programming a robot to perform tasks such as reaching into a bin or shelf, picking up items of arbitrary size, fragility, consistency, etc. As a result, large scale kitting operations have continued to be human labor intensive.

### BRIEF DESCRIPTION OF THE DRAWINGS

Various embodiments of the invention are disclosed in the following detailed description and the accompanying drawings.

FIG. 1 is a diagram illustrating a kitting system according to various embodiments.

FIG. 2A is a diagram illustrating a kitting system according to various embodiments.

FIG. 2B is a diagram illustrating a kitting system according to various embodiments.

FIG. 3A is a diagram illustrating a shelf system according to various embodiments.

FIG. 3B is a diagram illustrating a shelf system according to various embodiments.

FIG. 4A is a diagram illustrating a shelf system according to various embodiments.

FIG. 4B is a diagram illustrating a shelf system according to various embodiments.

FIG. 5A is a diagram illustrating a shelf system according to various embodiments.

FIG. 5B is a diagram illustrating a shelf system according to various embodiments.

FIG. 6A is a diagram illustrating a kitting system according to various embodiments.

FIG. 6B is a diagram illustrating a kitting system according to various embodiments.

FIG. 7 is a diagram illustrating a kitting system according to various embodiments.

FIG. 8A is a diagram illustrating a kitting system according to various embodiments.

FIG. 8B is a diagram illustrating a kitting system according to various embodiments.

FIG. 8C is a diagram illustrating a kitting system according to various embodiments.

FIG. 9 is a diagram illustrating a kitting system according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, kitting includes the picking of one or more items/objects from corresponding locations and placing the one or more items in a predetermined location in a manner that a set of the one or more items correspond to a kit.

“Kitting machines” or “kitting systems” and their integration into highly automated kitting operations are disclosed. In various embodiments, a kitting machine as disclosed herein comprises an at least partly robotically controlled unit that supplies and positions an item to facilitate the item being located, picked up, and/or positioned in and/or for packaging and/or shipment as part of a kitting operation. In various embodiments, a kitting machine as disclosed herein may comprise one or more kitting shelf machine modules (KSM), each comprising a modular component. A KSM as disclosed herein may comprise one or more shelves, bins, or other receptacles. In some embodiments, the shelves, bins, or other receptacles may be positioned via robotic control to position an item of pick up. A KSM as disclosed herein may be integrated with one or more other KSM's, one or more robotic arms, and/or other components to comprise an at least partly automated kitting system, capable of locating, selecting, and packing prescribed quantities of each of one or more arbitrary individual items, such as items included in an order, invoice, or similar data.

A kitting system configured to perform kitting is disclosed. In some embodiments, the kitting system includes a kitting shelf system that is used in connection with kitting. The kitting shelf system may include one or more shelves on which one or more items are stored for use in a kitting process for assembling one or more kits. The kits may be assembled based at least in part on a corresponding order (e.g., based on a packing slip associated with the order). Various embodiments include one or more robotic systems. A robotic system may include one or more robotic arms that are respectively configured to autonomously operate to pick an item/object from a first location and place the item/object in a second location. A robotic arm included in a kitting system may be controlled to operate (e.g., autonomously) pick and place the item/object according to a plan to assemble a kit.

According to various embodiments, the kitting shelf system controls the flow of items thereon and the kitting shelf system presents an item to a robotic system or human operator for removal of the item. The presentation of an item by the kitting shelf system is more effective and/or efficient than a shelfing used by traditional shelving systems. For example, the item is presented at an orientation (e.g., an angle) that improves line of sight towards the item on the kitting shelf system. A human operator or robotic system can more easily see the item and/or objects within the item while the item is on the kitting shelf system. As another example, the item is presented at a location and/or orientation that improves the ability of a robot arm to grasp the item from the kitting shelf system. In some embodiments, the kitting shelf system comprises a feeder portion, a presentation face, and a gate structure.

According to various embodiments, a feeder portion of the kitting shelf system receives items that are to be presented on at least one shelf. The feeder portion may be configured to receive a succession of items on the receiving end and convey the items to the destination end. Items may be manually loaded on the receiving end of the feeder portion (e.g., by a human operator), or automatically loaded on the receiving end such as via a conveyor system. In some embodiments, each shelf in the kitting shelf system comprises a corresponding feeder portion. The feeder portion may convey the items to the destination based on its orientation or based on a conveyance system. For example, the feeder portion may be oriented in a manner that gravity acts on the various items on the feeder portion to convey the items from the receiving end to the destination end. As another example, the feeder portion may include a conveyor that carries the items from the receiving end to the destination end or other element (e.g., a robotic element) that pushes the items along the feeder portion.

According to various embodiments, the presentation face of the kitting shelf system includes an area on which an item is presented for picking from the corresponding shelf. The kitting shelf system may be configured to control flow of items from the feeder portion to the presentation face such that the items are singly received on (e.g., conveyed to) the presentation face. The presentation face may singly receive an item in response to removal of a preceding item from the presentation face. For example, in response to a preceding item being removed from the presentation face, another item is singly conveyed from the feeder portion to the presentation face. In some embodiments, the presentation face is configured to hold a single item. The item may be a tray that includes one or more objects. In response to a determination that the item (e.g., the tray) is empty, the tray may be removed (e.g., by a robotic arm), and a succeeding item (e.g., a tray having objects therein) is conveyed to the presentation face.

In some embodiments, the kitting shelf system is configured to change an orientation of the presentation face. As an example, the kitting shelf may change the orientation of the presentation face based at least in part on whether the presentation face has an item disposed thereon. As another example, the kitting shelf system may configured to change an orientation of the presentation face based at least in part on a number of items disposed on the presentation face in relation to a threshold number of items. As another example, the kitting shelf system may be configured to change an orientation of the presentation face based at least in part on a weight of one or more items on the presentation face (e.g., a weight or force applied to the presentation face relative to a threshold weight or force). In some embodiments, the presentation face can be toggled between two positions—a position corresponding to the gate structure being in a closed position, and a position corresponding to the gate structure being in an open position. As an example, the presentation face may disposed in a first orientation to facilitate conveyance of an item from the feeder portion to the presentation face (e.g., when the gate structure is in an open position). As another example, the presentation face may be disposed in a second orientation to facilitate the picking of an item from the presentation face (e.g., by a robotic arm) and/or to facilitate capturing an image of the workspace such as an image of at least one or more items (or objects within an item) on the presentation face. According to various embodiments, the kitting shelf system is configured to dampen the movement of the presentation face (e.g., to dampen the movement of the presentation face between the first orientation and the second orientation). Dampening movement of the presentation face may help prevent movement of an item on the presentation face, and/or prevent an item from falling from the presentation face.

According to various embodiments, a gate structure of the kitting shelf system controls conveyance of an item from a feeder portion to a presentation face. The gate structure may be configured to toggle between at least a closed position and a closed position. In some embodiments, the gate structure is positioned in the closed position when an item being present on the presentation face (e.g., in response to an item being moved to the presentation face). In some embodiments, the gate structure is positioned in the open position when no items are on the presentation face (or a number of items on the presentation face is less than a threshold number of item). The gate structure may be moved to an open position and/or to a closed position based on a number of items on the presentation face (e.g., relative to a threshold number such as one). For example, the gate structure may be automatically moved to the open position in response to an item being removed from the presentation face. As another example, the gate structure may be automatically moved to the closed position in response to an item being moved to the presentation face (e.g., from the feeder portion). The gate structure may be moved to an open position and/or to a closed position based at least in part on a weight on (or force applied) the presentation face. For example, the gate structure may be automatically moved to the open position in response to a weight on (or force applied to) the presentation face is less than a threshold weight or a counteracting biasing force (e.g., applied to the presentation face). As another example, the gate structure may be automatically moved to the closed position in response to a weight on (or force applied to) the presentation face being greater than a threshold weight or a counteracting biasing force (e.g., applied to the presentation face). The number of the items on the presentation face or the weight on (or force applied to) the presentation face may be determined based at least in part on information obtained from one or more sensors. For example, the presence or absence of an item or the weight on the presentation face may be determined using an output from one or more weight sensors the measure a weight on the presentation face. As another example, the presence or absence of an item or a number of items on the presentation face can be determined based at least in part an image captured with respect to the workspace (e.g., an image of the presentation face). In some embodiments, a computer system operatively controls the gate structure (e.g., to be placed in an open position or a closed position). The computer system may control the gate structure based at least in part on the information obtained from the one or more sensors.

According to various embodiments, the kitting system picks and places one or more items (or objects from within the items on the presentation faces) according to a plan to assemble a kit. The plan may be determined based at least in part on an order (e.g., a packing slip corresponding to an order). The order may be an order from an electronic commerce website. The plan may be further determined based at least in part on information corresponding to the workspace (e.g., an attribute of an item of the workspace). The information corresponding to the workspace may be determined based at least in part on the sensor data obtained with respect to the workspace. As used herein, a workspace may include a kitting shelf system, a conveyance structure and/or receptacle on which items/objects are placed (e.g., in connection with assembling a kit), and/or a robotic system (e.g., one or more robotic arms that pick one or more items from the chute (or other source) and place the one or more items/objects each in a corresponding location on the conveyance structure/receptacle). The workspace may include a control computer that obtains sensor data associated with the workspace, and/or an on-demand teleoperation device that a human operator can use to control an element within the workspace such as the robotic arm and/or the conveyance structure. In some embodiments, the control computer determines the plan.

In various embodiments, an integrated kitting system as disclosed herein operates in an automated manner unless/until the system gets stuck and has no strategy available to continue automated operation. In some embodiments, in response to entering such a state the system requests human intervention, e.g., by manual assistance, teleoperation, etc.

In various embodiments, a robotic arm and/or a static, rail- or track-mounted, or mobile robot comprising a robotic arm or other appendage capable of retrieving items and placing the items in a destination, such as a box or other packaging, is integrated with one or more KSMs as disclosed herein such as a kitting shelf system. The robotic arm retrieves items, as applicable, from the associated KSM(s) and places them in a box or other packaging for shipment. As used herein, the terms slot, tray, or box, and/or receptacle may be used interchangeably in connection with describing a particular location on the conveyor.

Each item or object within an item on the kitting shelf may have machine readable information, such as text and/or optically or otherwise encoded information, which can be machine read and used in connection with kitting the object and/or item, e.g., via an automated kitting system and/or processing. As an example, to read the information for a given item (or object within the item), one or more sensors may obtain information pertaining to the item while the item is within the kitting shelf system (e.g., on a shelf of the kitting shelf system such as on a presentation face of the shelf, etc.). As another example, to read the information for a given item (or object within the item), one or more sensors may obtain information pertaining to the item while the item is being moved (by the robotic arm) from the kitting shelf system to the corresponding receptacle (e.g., the information pertaining to the item is scanned during a path/trajectory of the item from the kitting shelf system to the receptacle).

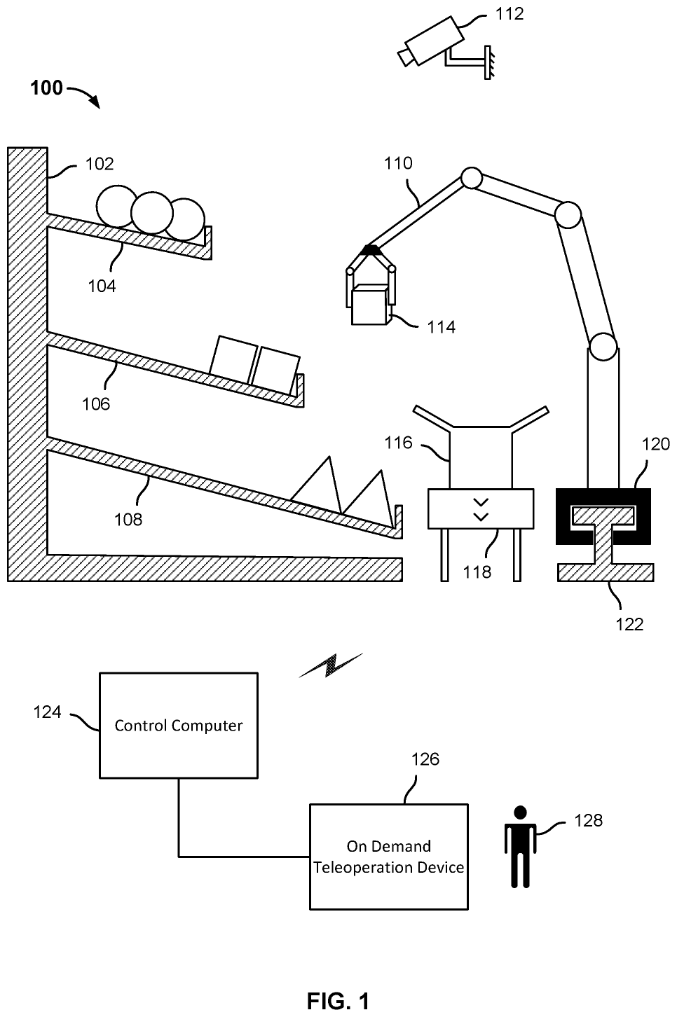

FIG. 1 is a diagram illustrating a kitting system according to various embodiments. In the example shown, kitting system 100 includes a kitting shelf system 102 and a robotic arm 110. In some embodiments, a kitting system includes a plurality of kitting shelf systems and/or a plurality of robotic arms 110. The robotic arm may operate autonomously to pick an item (or an object from within an item) from a kitting shelf system and place the item (or object) to a predetermined location. In some embodiments, a robotic arm picks and places one or more items to a predetermined location based at least in part on a plan such as a plan for kitting the one or more items (e.g., to assemble a kit based on an order etc.).

Kitting shelf system 102 includes one or more shelves 104, 106, and 108. In some embodiments, the one or more shelves 104, 106, and 108 respectively include one or more items disposed thereon. Different shelves within kitting shelf system 102 may include different items (e.g., a different type of item, items having one or more different identifiers such as serial numbers, model numbers, lot numbers, or the like).

In some embodiments, robotic arm 110 is movable with respect to kitting shelf system 102 and/or with respect to a conveyor or other location at which a receptacle is disposed. In the example shown in FIG. 1, robotic arm 110 is mounted on carriage 120, which is configured to ride along a rail or other linear guide 122 disposed alongside and substantially parallel to the conveyor 118, on a side opposite the kitting shelf system 102. In various embodiments, a motor, belt, chain, or other source of motive force is applied via a controller (not shown in FIG. 1) to move the carriage 120 and attached robotic arm 110 along the rail or guide 122 to facilitate the automated retrieval of items from one or more kitting shelf systems, and the placement of items (e.g., object 114) in receptacle 116 (e.g., a box, a tray, etc.) as the receptacle 116 is moved along conveyor 118. Control of robotic arm may be coordinated based at least in part on one or more items to be picked and placed in receptacle 116, a location of receptacle 116, and/or a path of receptacle 116 (e.g., based on a determined movement of conveyor 118).

In some embodiments, kitting system 100 includes control computer 124. In the example shown, operation of kitting shelf system 102, conveyor 118; and robotic arm 110, and/or carriage 120 are operated in a coordinated manner under the control of control computer 124. In the example shown, control computer 124 is in communication (e.g., wireless communication) with controllers, not shown in FIG. 1, each configured to control operation of a corresponding element comprising kitting system 100, e.g., kitting shelf system 102; robotic arm 110, conveyor 118, carriage 120, and/or receptacle source (not shown). Although wireless connections are shown in FIG. 1, in various embodiments wired connections or a combination of wired and wireless connections may be used.

In the example shown in FIG. 1, robotic arm 110 has an end effector corresponding to a two-digit gripper. In various embodiments, robotic arm 110 includes one or more other and/or different types of end effectors/retrieval tool, including without limitation a gripper having three or more digits; a gripper having digits with different attributes than as shown, e.g., cushioned digits, smaller digits, larger digits, etc.; and/or a retrieval tool that is not a gripper, such as one configured to pick up items using suction, friction, electrostatic force, magnetic force, etc. In some embodiments, the gripper of robotic arm 110 may be interchanged with one or more different end effectors, depending on one or more attributes of an item to be retrieved, e.g., weight, fragility, compressibility, rigidity, size, shape, etc. In some embodiments, the gripper of robotic arm 110 may be used to retrieve and use different end effectors (e.g., gripper-held tools) to pick and place items, depending on one or more attributes of the item to be retrieved, for example. One or more attributes of the items may be determined based at least in part on information obtained from one or more sensors such as camera 112.

In various embodiments, control computer 124 is configured, e.g., by software running on control computer 124, to receive data associated with an invoice, order, part list, pick list, or other list of items to be retrieved and packed together; determine a strategy/plan to fulfill the retrieve and pack the required items; and operate elements of kitting system 100, e.g., kitting shelf system 102; conveyor 118; and robotic arm 110 and/or carriage 120, in coordination to fulfill the requirement(s). In some embodiments, kitting system 100 includes a plurality of kitting shelf systems and/or a plurality of robotic arms, and one or more control computers are controlled to coordinate/operate elements of kitting system 100.

For example, in some embodiments, control computer 124 is configured to receive a list of items to be packed. Control computer 124 determines which items are associated with which of kitting shelf systems (or which items are associated with a particular shelf of a kitting shelf system such as kitting shelf system 102) and makes a plan to retrieve and pack the items. In some embodiments, computer 124 controls a box assembly machine (not shown) or a receptacle source module, and deposit a receptacle on conveyor 118 and controls the conveyor 118 to advance the receptacle to a position to be loaded with a first one or more items. The control computer 124 controls the carriage 120 and/or robotic arm 110 as needed to position the robotic arm 110 to retrieve the first one or more items from the associated a kitting shelf system (or a shelf 104, 106, or 108 of kitting shelf system 102). Control computer 124 may control kitting shelf system 102, e.g., to ensure the require item(s) in the required quantities are present in the pickup zone (e.g., a presentation face) at the end of kitting shelf system 102 (or a shelf 104, 106, and/or 108 of kitting shelf system 102) nearest to the conveyor 118 and robotic arm 110. Control computer 124 controls robotic arm 110 to retrieve the item(s) from the corresponding pickup zone(s) and places the item(s) in the receptacle (e.g., receptacle 116) before moving on to perform coordinated retrieval and packing of any further items required to be included in that particular kit. In response to a determination that all items have been retrieved and packed (e.g., according to a plan for kitting one or more items), control computer 124 controls conveyor 118 to advance the receptacle (e.g., receptacle 116) to a next stage of fulfillment, not shown in FIG. 1 (e.g., a station at which the box is sealed, labeled, and sent to be shipped).

In the example shown in FIG. 1, kitting shelf system 102 comprises angled shelves or angled conveyors (e.g., shelves 104, 106, and 108) that are configured to be loaded, e.g., by human workers, robots, and/or other machines, or some combination thereof, from a back end (upper/left as shown in FIG. 1). Items may be scanned, recognized by computer vision, etc. to determine and store on control computer 124 data associating the item and/or item type or other items attributes associated with each kitting shelf system. In various embodiments a mix of different types of kitting shelf systems may be included in a kitting system such as system 100. For example, the items shown in FIG. 1 as being supplied via kitting shelf system 102 may be supplied in some embodiments via a stationary ramp down which the items are rolled. In some embodiments, a kitting shelf system may comprise any one of a plurality of structures and mechanisms to supply items to an associated pick zone, including without limitation a gravity type conveyor having a plurality of adjacent rollers, a ramp, a conveyor belt, a set of revolving bins, etc.

In some embodiments, kitting shelf system 102 comprises one or more gating mechanisms that control conveyance of items to or within angled shelves or angled conveyors (e.g., shelves 104, 106, and 108). The one or more gating mechanisms may control the conveyance of one or more items to one or more presentation faces of the kitting shelf system in connection with the kitting of the one or more items (e.g., retrieval of the item(s) by a robotic arm and placement of the item(s) into a corresponding receptacle(s)). The one or more gating mechanisms may be controlled by control computer 124 or the one or more gating mechanisms may be configured to operate mechanically (e.g., without intervention by a control computer). In various embodiments, the one or more gating mechanisms control conveyance of the one or more items based at least in part on a plan (e.g., a predetermined plan for kitting an item based at least in part on an order).

In various embodiments, kitting system 100 is initialized by having control computer 124 determine through automated processing, manual configuration, and/or a combination thereof the placement, type, capabilities, etc. of each kitting shelf system (e.g., kitting shelf system 102) and the item(s) associated with each kitting shelf system. In addition, elements of kitting system 100 may register with the control computer 124. Registration may include admitting an element, such as each of the kitting shelf system, to a control network. In some embodiments, operational tests may be performed. For example, control computer 124 may test an ability to control a newly-registered element, such as by operating the conveyor belt of a kitting machine, such as kitting shelf system 102, in the forward and back directions, at various speeds, etc.

In various embodiments, elements of kitting system 100 may be added, removed, swapped out, etc. In such an instance, control computer 124 initializes and registers the new element, performs operational tests, and begins/resumes kitting operations, incorporating the newly added element, for example.

Referring further to FIG. 1, in the example shown kitting system 100 includes a camera 112 (e.g., a video camera) configured to capture images (e.g., video images) of the elements comprised in kiting system 100. Camera 112 may be one of a plurality of sensors that obtains information pertaining to the workspace (e.g., the workspace corresponding to kitting system 100). For example, camera 112 may be one of a plurality of sensors used by control computer 124 to control the elements comprising kitting system 100. For example, in the example shown, video generated by camera 112 and sent to control computer 124 may be used by control computer 124 to control the speed and/or direction of the conveyor belts comprised in the kitting shelf system 102 and/or a gating mechanism in the kitting shelf system 102 to ensure a sufficient and not excessive number of items are available in the pickup zone (e.g., a presentation face of kitting shelf system 102) and/or to position or reposition the items for retrieval by robotic arm 110. In addition, camera 112 and/or other cameras and/or other sensors may be used to facilitate robotic arm 110 picking up an item and/or placing the item in its receptacle (e.g., box). In various embodiments, a plurality of cameras may be deployed in a number of locations, including in the environment and on the respective elements comprising system 100, to facilitate automated (and, if needed, human assisted) kitting operations. In various embodiments, sensors other than cameras may be deployed, including without limitation contact or limit switches, pressure sensors, weight sensors, and the like.

In various embodiments, one or more sensors are disposed on a chassis of the robotic arm or a chassis of a robotic structure on which the robotic arm is disposed. System 100 may include one or more accelerometers operatively connected to or disposed within proximity of the one or more sensors (e.g., the one or more cameras). The control computer may obtain the image data pertaining to the workspace based at least in part on information obtained by the one or more accelerometers. In some embodiments, the one or more sensors may comprise a scanner that obtains data pertaining to a label or identifier on the object as the object is moved from the item to the predetermined structure.

In various embodiments, one or more sensors (e.g., camera 112) is used to capture information pertaining to items associated with kitting shelf system 102. For example, camera 112 may capture an image of one or more items on shelf 104, shelf 106, and/or shelf 108. As another example, if an item on a shelf 104, shelf 106, and/or shelf 108 is a tray or other receptacle, camera 112 may capture information pertaining to objects within the tray. Control computer 124 may use information pertaining to the workspace to determine a plan, and/or to control operation of robotic arm 110 to pick an item (or an object from within the item) from kitting shelf system 102. Control computer 124 may use the information pertaining to the workspace in connection with determining a location of an object within a tray on shelf 104, shelf 106, and/or shelf 108; a quantity of objects within the tray; a type of object within the tray; an orientation of one or more objects within the tray; etc.

In various embodiments, control computer 124 is programmed to determine a plan to fulfill a kitting requirement based at least in part on a model of the robotic arm 110 and other elements comprised in kitting system 100, e.g., kitting shelf system 102; conveyor 118; a receptacle source module (e.g., a box assembly machine) (not shown); robotic arm 110; and/or carriage 120. The respective models in various embodiments reflect capabilities and limitations of each respective element. For example, the shelves 104, 106, and 108 of kitting shelf system 102 are in fixed positions in this example, but each has a conveyor belt which may be capable of being moved in forward and back directions and/or at different speeds. In addition, the control computer 124 may use information stored in connection with initialization and/or configuration, e.g., which items are on which location(s) on which kitting shelf system (or on which shelf of which kitting shelf system), where each kitting shelf system and/or its associated pick up zone (e.g., presentation face(s)) is located, etc., to determine a plan to fulfill a requirement. In addition, control computer 124 may use data determine based at least in part on sensor data, such as video captured by camera 112, to make a plan to fulfill a requirement.

According to various embodiments, kitting of items from one or more kitting shelf systems is improved through use of a dynamic kitting method or system that determines a path or trajectory for kitting of an item using one or more of an attribute of the item to be singulated and an attribute of another item within the workspace (e.g., an item and/or receptacle on the conveyor). The dynamic kitting method or system may include an updating of the path or trajectory for kitting of an item in response detecting one or more of an attribute of the item to be kitted and an attribute of another item within the workspace (e.g., an item on the conveyor). The dynamic kitting method or system may include an updating of the conveyance of an item from a feeder portion of a kitting shelf system to a presentation face of the kitting shelf system in connection with kitting of an item (or object from an item on the kitting shelf system) in response to determining an attribute of the workspace. The attribute of the workspace used in connection with updating the plan for kitting the item/object may include an attribute of an item/object to be kitted, a quantity of objects within an item (e.g., a tray on a kitting shelf system), a speed of the conveyor, a characteristic associated with a receptacle on the conveyor, an orientation of the item on the kitting shelf system, an orientation of a presentation face of the kitting shelf system, etc. In some embodiments, the kitting system 100 (e.g., control computer 124) dynamically updates the plan for kitting the item during kitting based on a context of the workspace (e.g., a state or condition of the item, a property of the item, another item within the workspace, a speed of conveyor 118, an identifier of receptacle 116, etc.).

In various embodiments, control computer 124 is configured to formulate and/or update or reformulate a plan to fulfill a requirement, and to implement or attempt to implement the plan, by employing strategies to do a (next) task or subtask that have been programmed into and/or learned by control computer 124. Examples include, without limitation, strategies to use robotic arm 110 to pick up a given item (or an object from an item on a presentation face of a kitting shelf system) based on attributes of the item (rigidity, fragility, shape, orientation, etc.). In some embodiments, control computer 124 is programmed to use a first (e.g., preferred or best) strategy to attempt to perform a task (e.g., pick up an item with robotic arm 110), and if the first strategy fails then to determine and use an alternate strategy, if one is available (e.g., use the robotic arm 110 to nudge the item (or object) then try again, operate the conveyor or other instrumentality of the kitting shelf system 102 (or of a shelf of kitting shelf system), forward and/or backward a bit and try again, etc.). The preferred or best strategy can be determined based at least in part on a model associated with a likelihood of successful picking and placing the object, etc.

In the example shown in FIG. 1, control computer 124 is connected to an on demand teleoperation device 126 operated by a human operator 128. While in FIG. 1 teleoperation device 126 is operated by a human operator 128, in some embodiments teleoperation device 126 may be operated by a non-human operator, such as a highly skilled robot. In various embodiments, control computer 124 is configured to invoke on demand teleoperation based at least in part on a determination by control computer 124 that control computer 124 does not have an available strategy to continue/complete a kitting operation and/or a component task thereof through fully automated operation. For example, an item is dropped in a location from which the robotic arm 110 cannot retrieve the item; or, an item has been attempted to be picked up a prescribed maximum number of attempts and has not successfully been retrieved; operation of and end effector deviates from a defined normal operation (e.g., if a suction cup is broken), etc. Based on such a determination, control computer 124 sends an alert or other communication to on demand teleoperation device 126, prompting human operator 128 to use teleoperation device 126 to operate one or more elements of kitting system 100—e.g., one or more of kitting shelf system 102 (or shelf 104, 106, and/or shelf 108); conveyor 118; a receptacle source module (e.g., a box assembly machine) (not shown); robotic arm 110; and/or carriage 118—to perform at least the task or subtask the kitting system 100 was not able to complete under fully automated control by control computer 124.

Examples of teleoperation device 126 include without limitation a tablet or other mobile device having a graphical user interface to control elements of system 100, a desktop or other computer having one or more input devices connected thereto to operate elements of system 100 remotely, etc.

While in some embodiments control computer 124 invokes on demand teleoperation, in some embodiments a human operator such as operator 128 may monitor automated operation of kitting system 100, e.g. via a video feed generated by camera 124, and may intervene to operate elements of system 100 by teleoperation if the human operator determines there is a need to intervene or assist.

In various embodiments, teleoperation device 126 and/or human operator 128 may be located remotely from a physical site at which kitting system 100 is located and operates (mostly) in a fully automated mode. Similarly, control computer 124 may be located remotely from the site at which other elements of system 100 are located and/or a portion of the work described herein as being performed by control computer 124 may be performed by a computer located remotely from that site.

In various embodiments, control computer 124 is configured to learn new or improved strategies to employ elements of kitting system 100 to perform kitting operations. For example, control computer 124 in some embodiments is programmed to record actions by a human operator (128) via teleoperation (126) and to update its model(s), strategies, etc., as appropriate to be able to repeat and/or emulate the actions of the human operator to perform the task or subtask for which teleoperation was required.

In various embodiments, control computer 124 is configured to continue to evaluate, during teleoperation, whether it has a viable plan and/or strategy to resume automated fulfillment of the current requirement. If so, control computer may be configured to resume automated operation, either proactively or by advising the human operator that control can be returned to control computer 124.

While in the example shown in FIG. 1 receptacles (e.g., receptacle 116) are moved by conveyor 118 into successive positions opposite kitting shelf systems or robotic arms, in other embodiments the receptacles may be place in a single, central position, by conveyor 118 or in some embodiments manually or by a machine other than conveyor 118, and may be filled by moving the robotic arm 110 into one or more positions to access and pick up items from the kitting shelf systems (or shelves of the kitting shelf system, such as shelves 104, 106, and 108), and place the items in the corresponding receptacles (e.g., receptacle 116).

While a “kitting” operation is shown in FIG. 1 and described herein with reference to FIG. 1 and other Figures, in various embodiments kitting systems (and kitting shelf systems) and integrated systems as disclosed herein may be used to perform the reverse operation, e.g., by stocking shelves, bins, and/or kitting machines with items removed from an initially full or partly full box of items. For example, in the example shown in FIG. 1, the receptacle 116 may include a plurality of items associated with kitting shelf system 102, and robotic arm 110 may be used to remove items from the receptacle 116 and place the items on the kitting shelf system 102, e.g., from the back or supply end as shown. In some embodiments, a robotic arm provides items (e.g., stocks items) to a feeder portion of a shelf or a feeder portion of a kitting shelf system.

In some embodiments, items on a kitting shelf system, such as kitting shelf system 102, or on a shelf accessed by, or comprised in, a kitting system as disclosed herein, may be bins or trays that comprise objects that are to be “kitted”. In some embodiments, the system (e.g., kitting system 100 of FIG. 1) is configured to detect, e.g., based on computer vision or other sensors and/or techniques, that a bin is empty, and to clear the bin from the kitting system or shelf by using a robotic arm to pick up the bin and place it in a corresponding empty bin location, e.g., a nearby stack of empty bins, etc. In some embodiments, automated bin clearing makes room from a next bin that is not empty to move into position on the kitting machine or shelf to enable a robotic arm to access and pick up items from the bin. In some embodiments, in response to determining that a bin/tray is empty, a robotic arm (e.g., robotic arm 110) removes the bin/tray from the corresponding shelf of kitting shelf system 102 and uses the empty bin/tray as a subsequent receptacle for kitting other items/objects. For example, robotic arm 110 can pick up an empty bin/tray from a shelf and place the empty bin/tray on conveyor 118 for use as a receptacle (e.g., receptacle 116).

In various embodiments, a robotic system as disclosed herein includes and/or does one or more of the following, e.g., by operation of a control computer such as control computer 124:
Computer vision information is generated by merging data from multiple sensors, including one or more of 2D cameras, 3D (e.g., RGBD) cameras, infrared, and other sensors to generate a three-dimensional view of a workspace that includes one or more kitting shelf systems (which may correspondingly include one or more shelves of the kitting shelf system). The robotic system determines characteristics of items and/or debris or other abnormalities in the tree-dimensional view of the workspace.
Robotic system coordinates operation of multiple robots to avoid collisions, getting in each other's way, and contending to pick up the same item and/or place an item in the same destination location (e.g., receptacle on the conveyor) as another robot. The robotic system coordinates operation of a plurality of robots operating within a same workspace to perform kitting with respect to a plurality of items/object (e.g., to kit items in different receptacles or within a same receptacle). As an example, in various embodiments, the plurality of robots operate independently to pick and place items. As another example, the plurality of robots operate to independently pick and place items for different orders (e.g., to place different sets of items in different receptacles). If a risk of collision is detected, responsive action is taken to ensure the plurality of robots do not collide with one another during singulation.
Robotic system coordinates operation of multiple robots to ensure all items are placed in corresponding receptacles. For example, if robot A drops an item system tasks robot B to pick it up; item placed but with improper orientation is picked up and adjusted or moved to another location by same or another robot; two or more items for different orders are placed in a single receptacle results in a downstream robot picking one of the two or more items from the receptacle and placing the item in a new receptacle; etc.
Robotic system continuously updates motion planning for each robot and all of the robots together to achieve a desired collective throughput (e.g., to maximize collective throughput, to attain a predefined threshold of collective throughput, etc.). In response to determining that two or more robots have collided or will collide if moving according to their respective plans for kitting items, the robotic system implements an active measure to ensure that the two or more robots avoid collision or otherwise reset independent operation of the two or more robots.
In response to a determination that two robots independently are tasked to acquire the same item, the system picks one at random to get that item and the other moves on to the next item (e.g., identify, select, determine grasp strategy, pick, move according to plan, and place).
The robotic system can manage the independent operation of a plurality of robots to ensure that the robots select items at different times to avoid the same item being selected for singulation by two different robots.
Conveyor movement and/or speed controlled as needed to achieve a desired robot productivity (throughput) and to permit sufficient time for the robot to place an object into the desired receptacle.
In response to a determination that an item is misplaced or dropped, the system assigns a robot or, if needed, a human worker to pick the misplaced item up and place the item back in the applicable kitting shelf system (e.g., on a shelf such as via the feeder portion) or, if available or more optimal, on a receptacle on the conveyor.
Upstream robots controlled to intentionally leave some receptacles open for downstream robots to place items on the conveyor (e.g., in the corresponding receptacles).
Downstream robots controlled to correct errors from an upstream placing an item in a receptacle on the conveyor (e.g., to correct the placement of an item that rests in more than one receptacle such as a tray, or that rests on the conveyor rather than the applicable receptacle, to update a data structure with an association between an identifier for the item or kit/order with the receptacle in which the upstream robot placed the item, etc.).
Failure that cannot be corrected by same or another robot results in an alert being communicated to obtain human (or other robotic) intervention to resolve.
In response to a determination that a grip strength (e.g., a pressure attained by the end effector) is abnormal (e.g., less than is expected during normal operation), perform a diagnostic process that includes testing the grip strength on a predefined surface and in connection with determining whether remedial action is necessary with respect to the end effector.
Move/remove the debris within the workspace, or to reconfigure an item to be kitted (e.g., to improve the likelihood that the item is successfully picked from the shelf, or the presentation face of the shelf, and placed on the conveyor such as in a receptacle on the conveyor).
Use sensor data from the workspace environment state system to detect one or more characteristics (e.g., attributes) of the item selected for kitting, determine that grasping or releasing of the item is expected to improve in response to implementation of an active measure, and implement the active measure to improve the grasping or releasing of the item.
Use sensor data to determine that the robotic arm has grasped a plurality of items in connection with kitting of one of the items, determine a plan for releasing the plurality of items in order to place each item singly in a corresponding location in one or more receptacles on the conveyor or to place one of the items back on the shelf/presentation face of the kitting shelf system (e.g., determine a strategy for operating the end effector to release a first subset of the plurality of items at a different time from a second subset of the plurality of items).
Select a path for kitting an item to a receptacle on the conveyor based on an attribute of the item (e.g., a size of the selected item, a weight of the item, etc.) and/or one or more attributes (e.g., characteristics) of an item within a receptacle on the conveyor.
Determine a movement and speed of the robotic arm that picks an item from the kitting shelf system and places the item in the applicable receptacle based at least in part on a speed of a conveyor belt.
Determine a trajectory of the item to be kitted based at least in part on one or more of a characteristic of the item, a characteristic of the workspace environment, and/or a characteristic of the conveyor (e.g., a speed of the conveyor belt).
Determine a probability of successful kitting corresponding to one or more paths/trajectories of an item to be kitted, and select a path/trajectory along which the item is to be kitted based on the corresponding probability of success.
Determine a positioning of a robot arm and/or an end effector of the robot arm to obtain a successful grasp (e.g., as determined based on a probability of grasp success, a type of packaging of the item, a dimension of the item, an expected grip strength in relation to a threshold value, etc.). The positioning of the end effector can include controlling the robot arm or a wrist of the robot arm to move in order for the end effector be orthogonal to a surface of the item.
Update the ability of the robotic system to detect an empty receptacle. For example, the definition of an empty receptacle used by the robotic system to identify an empty receptacle is updated over time.

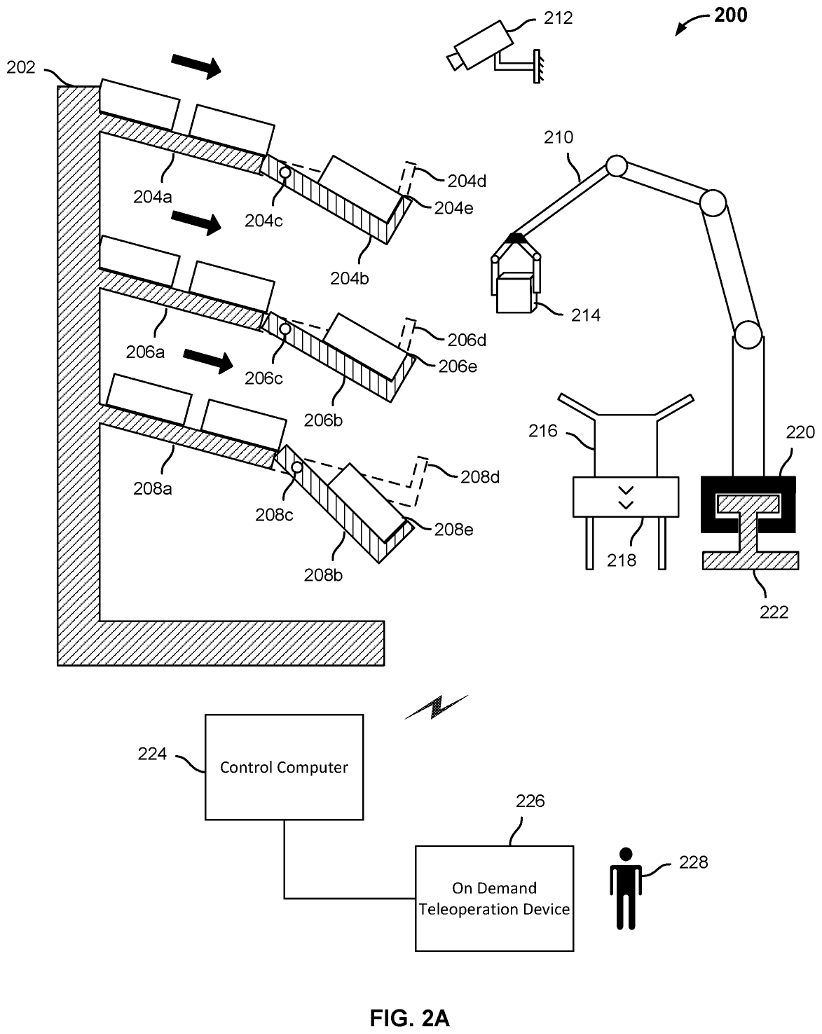

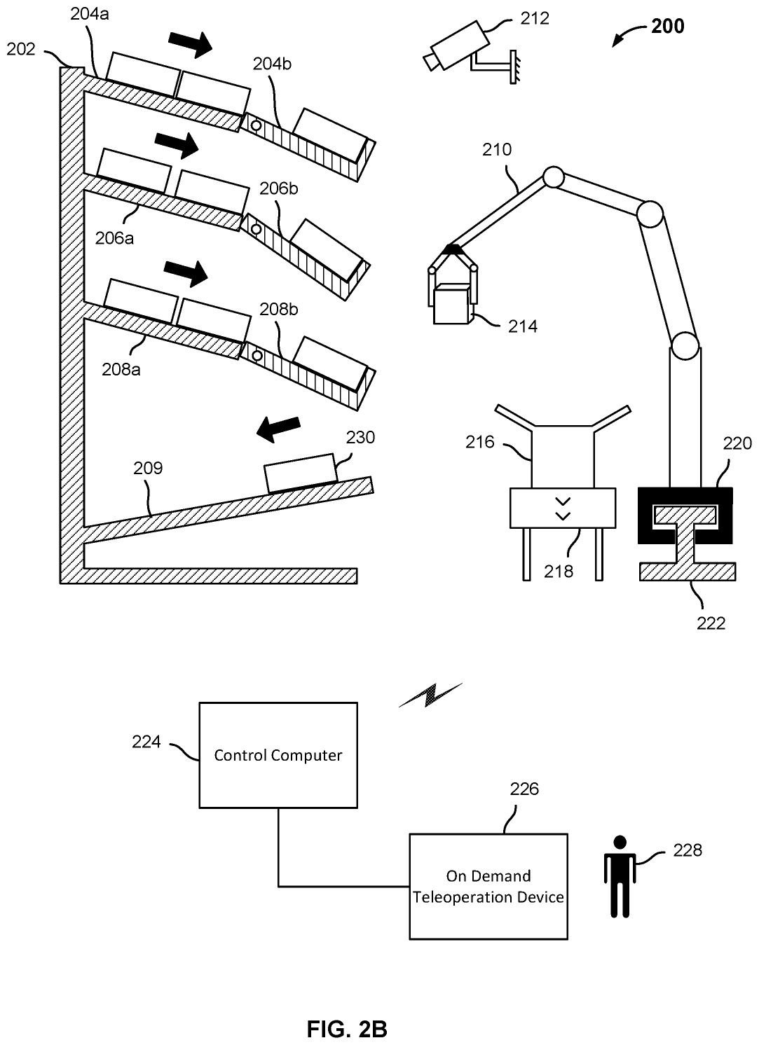

FIG. 2A is a diagram illustrating a kitting system according to various embodiments.

In the example shown, kitting system 200 includes a kitting shelf system 202 and a robotic arm 210. According to various embodiments, kitting shelf system 202 includes one or more shelves. Each of the one or more shelves comprises a presentation face (e.g., presentation face 204b, presentation face 206b, and/or presentation face 208b). The presentation face corresponds to an area or surface on which an item is disposed on the kitting shelf system. In connection with kitting of one or more items, robotic arm picks an item (or object from within an item) from at least one presentation face. Kitting shelf system 202 may include one or more feeder portions (e.g., feeder portion 204a, feeder portion 204b, and/or feeder portion 204c). In some embodiments, kitting shelf system 204 includes a gate structure (e.g., gate structure 204c, gate structure 206c, and/or gate structure 208c) that is configured to control conveyance of an item from a feeder portion to the corresponding presentation face. The gate structure may be coupled to, or integrated with, the presentation face.

In some embodiments, robotic arm 210 is movable with respect to kitting shelf system 200 and/or with respect to a conveyor or other location at which a receptacle is disposed. In the example shown in FIG. 2A, robotic arm 210 is mounted on carriage 220, which is configured to ride along a rail or other linear guide 222 disposed alongside and substantially parallel to the conveyor 218. As an example, the robotic arm 210 may be mounted on a side opposite the kitting shelf system 200. As an example, the robotic arm 210 may be mounted on a same side as the kitting shelf system 200. In some embodiments, one or more robotic arms are mounted on a same side of conveyor 218 as a kitting shelf system and one or more robotic arms are mounted on a side of conveyor 218 that is opposing to kitting shelf system. In various embodiments, a motor, belt, chain, or other source of motive force is applied via a controller (not shown in FIG. 1) to move the carriage 210 and attached robotic arm 210 along the rail or guide 222 to facilitate the automated retrieval of items from one or more kitting shelf systems, and the placement of items (e.g., object 214) in receptacle 218 (e.g., a box, a tray, etc.) as the receptacle 216 is moved along conveyor 218. Control of robotic arm may be coordinated based at least in part on one or more items to be picked and placed in receptacle 216, a location of receptacle 216 (e.g., a predetermined location at which the item is to be kitted), and/or a path of receptacle 216 (e.g., based on a determined movement of conveyor 218).

In some embodiments, kitting system 200 includes control computer 224 and/or on operation teleoperation device 226. In the example shown, operation of kitting shelf system 202, conveyor 218; and robotic arm 210, and/or carriage 220 are operated in a coordinated manner under the control of control computer 224. In the example shown, control computer 224 is in communication (e.g., wireless communication) with controllers, not shown in FIG. 2A, each configured to control operation of a corresponding element comprising kitting system 200, e.g., kitting shelf system 202; robotic arm 210, conveyor 218, carriage 220, and/or receptacle source (not shown). Although wireless connections are shown in FIG. 2A, in various embodiments wired connections or a combination of wired and wireless connections may be used.

In some embodiments, the gate structure controls flow of items from the feeder portion to the presentation face. The gate structure may serve to isolate an item (e.g., a tray from which objects are picked) to facilitate easier removal of the tray upon a determination that the tray is empty. The isolation of the tray by the gate structure allows for the tray to be removed from the corresponding shelf (e.g., the presentation face) without the tray contacting other trays on the shelf (e.g., buffer trays such as the trays on the feeder portion behind the gate). Incidental contact between an empty tray (e.g., during removal of the tray) with buffer trays may cause the robotic arm to drop the empty try, or may cause one or more of the buffer trays to become misaligned or jammed.

According to various embodiments, the gate structure permits or prevents an item to flow from a feeder portion to the presentation face. The control of flow of items from the feeder portion to the presentation face may prevent items from being cluttered on the presentation face and can assist with providing sufficient space and order of items on the presentation face for a robotic arm to pick and place an item/object from the presentation face. Limiting the number of items on a presentation face (e.g., controlling the flow of items) may also improve the sensing or perception of items on the presentation face, and/or prevent an overflowing of items to the presentation face, which could cause an uncontrolled motion of items. The gate structure may be configured to prevent/inhibit more than a threshold of items to be disposed on a presentation face at any particular time. In some embodiments, the gate structure is toggled (e.g., moved) between an open position and a closed position. As an example, the open position may correspond to an orientation of the gate structure when no item is present on the presentation face. As another example, the open position may correspond to an orientation of the gate structure when a quantity of items on the presentation of items is less than a threshold number of items. As another example, the open position may correspond to an orientation of the gate structure when a weight on (or force applied to) to the presentation face is less than a threshold weight (or threshold force). When the gate structure is oriented in the open position, a flow or conveyance of an item from the feeder portion to the presentation face may be permitted (e.g., unblocked). Conversely, when the gate structure is oriented in the closed position, a flow or conveyance of an item from the feeder portion to the presentation face may be prevented (e.g., the flow of items is blocked). In the example illustrated in FIG. 2A, a portion of the presentation faces 204b, 206b, and/or 208b is used to block conveyance of items from the corresponding feeder portions 204a, 206a, and/or 208a; the corresponding gate portions 204c, 206c, and/or 208c may be hinges operatively coupled to presentation faces 204b, 206b, and/or 208b. In some embodiments, the gate structure is configured to move an element that is distinct from the corresponding presentation face in with moving to an open position and/or closed portion.

In some embodiments, the gate structure is mechanically operated (e.g., to move between the open position and the closed position) based at least in part on a weight (e.g., a weight of an item, if any) applied to the corresponding presentation face. The gate structure may include a biasing element that biases the gate structure to be oriented in the open position. If a force applied to the presentation face (e.g., corresponding to the weight of the item on the presentation face) exceeds the biasing of the gate structure, the gate structure may operate to orient in the closed position. In some embodiments, the gate structure is electromechanically operated. For example, the gate structure may receive a signal and based at least in part on the signal the gate structure may operate in a closed position or an open position. The signal may be provided by a computer, such as control computer 224. The signal to control the gate structure may be determined/provided based at least in part on information obtained by one or more sensors in the workspace. For example, image data obtained by camera 212 of kitting system 200 may be used in connection with determining whether to gate structure is to be oriented in the open position or closed position (e.g., based at least in part on a determination of whether an item is disposed on the corresponding presentation face). Information obtained by one or more other sensors may be used in connection with determining whether to control the gate structure is to be oriented in the open position or closed position. Examples of sensors that may be implemented to obtain such information include a weight sensor, a force sensor, a torque sensor, a pressure sensor, an infrared sensor, etc. The information used in connection with determining whether to control the gate structure to be oriented in the open position or closed position may be used to determine whether an item is on the corresponding presentation face, to determine whether an item(s) on the presentation face exceed a threshold value (e.g., a threshold weight, a threshold force), etc. As an example, a model of information obtained by the one or more sensors may be generated. The model may determine/define information that is indicative of whether an item is present on the presentation face, or whether a quantity of items present on the presentation face is less than a threshold quantity of items, etc. The control computer 224 may use the model to determine whether to control the gate structure to be oriented in the open position or the closed position. For example, in response to determining that an item is present on the presentation face, the control computer 224 may send a signal to the gate structure to cause the gate structure to move to a closed position (e.g., thereby preventing conveyance of further items to the presentation face).

As illustrated in FIG. 2A, a presentation face (e.g., presentation face 204b, presentation face 206b, and/or presentation face 208b) is movable. For example, the presentation face toggle between an empty position (denoted by 204d, 206d, and 208d) and an occupied position (denoted by 204b, 206b, and 208b). Although the example illustrated in FIG. 2A illustrates the presentation face toggling between two positions/orientations, the kitting shelf system 202 may be configured for the presentation face to be moved to orient in one of a plurality of positions/orientations. For example, the presentation face may be oriented in any one of the plurality of positions/orientations based at least in part on a context of the workspace (e.g., an item to be provided on the presentation face, a location of a robotic arm to pick the item, a size of the robotic arm, a location of a sensor or camera, etc.).

In various embodiments, the empty position corresponds to a position at which the presentation face is oriented to facilitate a flow/conveyance of one or more items from the feeder portion to the presentation face. For example, the empty position may correspond to a position at which the presentation face is oriented when a quantity of items on the presentation face is less than a threshold number. As another example, the empty position corresponds to a position at which the presentation face is oriented when the presentation face is empty (e.g., does not have any items disposed thereon). As another example, the empty position corresponds to a position at which the presentation face is oriented when a weight on (or force applied to) the presentation is less than a threshold weight (or threshold force). In some embodiments, each presentation face in a particular kitting shelf system (e.g., kitting shelf system 202) may have a same angle of orientation (e.g., such as an angle relative to a normal to the ground) when orientated in corresponding empty positions. In some embodiments, two or more presentation faces in a particular kitting shelf system (e.g., kitting shelf system 202) have different angles of orientation (e.g., such as an angle relative to a normal to the ground) when orientated in corresponding empty positions. As an example, a first set of one or more presentation faces has an angle of orientation that is different from an angle of orientation of a second set of one or more presentation faces. As another example, each presentation face within a particular kitting shelf system has a different angle of orientation (e.g., such as an angle relative to a normal to the ground) when orientated in a corresponding empty position. The shelves (e.g., at least one of the corresponding feeder portion and the kitting portion) on a kitting shelf system can be configured at different angles based on a height of the shelf relative to the ground. The configuring of shelves at different angles may permit a better line of sight for sensors in the workspace, such as camera 212, and such a configuration may improve the information pertaining to the workspace (e.g., identifiers on the items may be obtained more easily or accurately, etc.).

In some embodiments, a bottom shelf on which items are presented (e.g., a shelf from which an item may be obtained such as the shelf corresponding to feeder portion 208a) has a corresponding presentation face 208b that has less of a range of motion than presentation faces of higher shelves such as presentation face 204b and 206b. The presentation face on such a bottom shelf may be fixed relative to the feeder portion. For example, the presentation face on such a bottom shelf may be integrated with the feeder portion or not otherwise change positions relative to the feeder portion. Such a bottom shelf or the presentation face of such bottom shelf (e.g., presentation face 208b) may have a shallower pitch/angle than one or more higher shelves or of the presentation faces for the one or more higher shelves (e.g., presentation face 204b and/or 206b). In some embodiments, shelves (e.g., presentation faces of such shelves such as when an item is on the presentation face) has a progressively shallower pitch or angle the lower the shelf is on the kitting shelf system such as kitting shelf system 200.

In various embodiments, the occupied position corresponds to a position at which the presentation face is oriented to facilitate picking of one or more items (e.g., by the robotic arm) from the presentation face. The presentation face may be oriented in the occupied position when conveyance/flow of one or more items from the feeder portion to the presentation face is to be prevented. In some embodiments, each presentation face in a particular kitting shelf system (e.g., kitting shelf system 202) may have a same angle of orientation (e.g., such as an angle relative to a normal to the ground) when orientated in corresponding empty positions. In some embodiments, two or more presentation faces in a particular kitting shelf system have different angles of orientation (e.g., such as an angle relative to a normal to the ground) when orientated in corresponding occupied positions. As an example, a first set of one or more presentation faces has an angle of orientation that is different from an angle of orientation of a second set of one or more presentation faces. As another example, each presentation face within a particular kitting shelf system has a different angle of orientation (e.g., such as an angle relative to a normal to the ground) when orientated in corresponding occupied positions. As illustrated in FIG. 2A, the shelves (e.g., at least one of the corresponding feeder portion and the kitting portion) on a kitting shelf system can be configured at different angles based on a height of the shelf relative to the ground. The configuring of shelves at different angles may permit a better line of sight for sensors in the workspace, such as camera 212, and such a configuration may improve the information pertaining to the workspace (e.g., identifiers on the items may be obtained more easily or accurately, etc.).

In some embodiments, the orientation of the presentation face may have a greater tilt downwards the lower the corresponding shelf is to the ground. Such an orientation of the presentation face may enhance one or more sensors (e.g., camera 212) to obtain information pertaining to the presentation shelf or one or more items/objects on the presentation face. In addition, such an orientation may enhance the ability of the robotic arm to engage an item with the end effector of the robotic arm. A robotic arm may have limitations with respect to its wrist extension capabilities/configurations and/or its wrist flexion capabilities/configurations. As an example, the orientation of the presentation face (e.g., at least in the occupied position) is configured based at least in part on an extent of wrist extension that is required by a robotic arm to pick the item/object from the presentation face). The shelf/presentation face may be configured based at least in part on the range of motion of a wrist of a robotic arm in the kitting shelf system (e.g., a range of motion with respect to wrist extension/flexion). An end effector or wrist component of the robotic arm may have size limitations that inhibit the ability of the robotic arm to engage (e.g., at certain angles and heights/locations) an item disposed on a presentation face. Accordingly, the orientation of the presentation face (e.g., at least in an occupied position) of a shelf may be configured to improve the likelihood/ability of the robotic arm to configure its position to engage an item/object on the presentation face with an end effector of the robotic arm at an orthogonal relative to the item/object. The orientation of the presentation face when in the occupied position can correspond to an orientation in which a tray/item disposed thereon is optimally angled (at each level/shelf) for a better vision from an onboard camera (e.g., a camera disposed in the workspace and/or on a robotic arm or chassis thereof). In some embodiments the orientation of the presentation face in the empty position and/or occupied position is based at least in part on a configuration of the corresponding gate structure. For example, if the gate structure is a hinge, the orientation of the presentation face in the empty position and/or occupied position is based at least in part on a range of motion of the hinge.

According to various embodiments, kitting shelf system 202 includes one or more feeder portions (e.g., 204a, 206a, and/or 208a). In some embodiments, the kitting shelf system 202 may have a single feeder portion that conveys one or more items to a plurality of presentation faces. In other embodiments, as illustrated in FIG. 2A, the kitting shelf system 202 has a single feeder portion for each presentation face (e.g., a one-to-one mapping of feeder portions to presentation faces). The feeder portion may be configured to convey an item to a presentation face. As an example, the conveyance of the item may be passive such as via gravity acting on an item disposed on the feeder portion (e.g., in the case that the feeder portion is configured to tilt towards the presentation face). As another example, the conveyance of the item may be at least partially active based on the feeder portion being configured with a conveyor that carries an item from an input location of the feeder portion to the presentation face. In various embodiments, the feeder portion configured to receive a succession of items on a receiving end (e.g., an input to the feeder portion) and convey the items to a destination end (e.g., an end that is operatively connected/coupled to a presentation face or that otherwise exits the feeder portion to the applicable presentation face). The succession of items may be manually loaded to the feeder portion or kitting shelf system (e.g., via a human operator 228), or the succession of items may be automatically loaded to the feeder portion (e.g., via a robotic arm/component, or based at least in part on the feeder portion being coupled to a chute that conveys items from a source flow/pile).

FIG. 2B is a diagram illustrating a kitting system according to various embodiments. As illustrated in FIG. 2B, kitting shelf system 202 can be further configured with return portion 209. According to various embodiments, an item can returned to a predetermined location via return portion 209. The item may be returned in response to a determination that the item is empty (e.g., all objects within item have been kitted to corresponding receptacles); in response to a determination that the item is defective; in response to a determination that the item was not in a correct location (e.g., the item was improperly conveyed to the presentation face such as based at least in part on a type of objects within the item, etc.); etc.

In various embodiments, the return portion 209 is configured to convey an item (e.g., item 230 in FIG. 2B) to a predetermined location. The conveyance of the item on the return portion 209 may be passive such as via gravity acting on an item disposed on the return portion 209 (e.g., in the case that the return portion is configured to tilt towards the predetermined location). As another example, the conveyance of the item 230 may be at least partially active based on the feeder portion being configured with a conveyor that carries an item from an input location of the return portion to the predetermined location. In various embodiments, the feeder portion configured to receive a succession of items on a receiving end (e.g., an input to the return portion) and convey the items to a destination end (e.g., an end that is operatively connected/coupled to the predetermined location or that otherwise exits the return portion). The succession of items (to be returned) may be manually loaded to the return portion (e.g., by human operator 228), or the succession of items may be automatically loaded to the feeder portion (e.g., via a robotic arm/component).

According to various embodiments, the predetermined location to which items (e.g., item 230) are returned corresponds to a system in which the items are recycled or re-populated with objects so that the items may be recirculated into the kitting system (e.g., reloaded to a feeder portion of kitting shelf system 202).

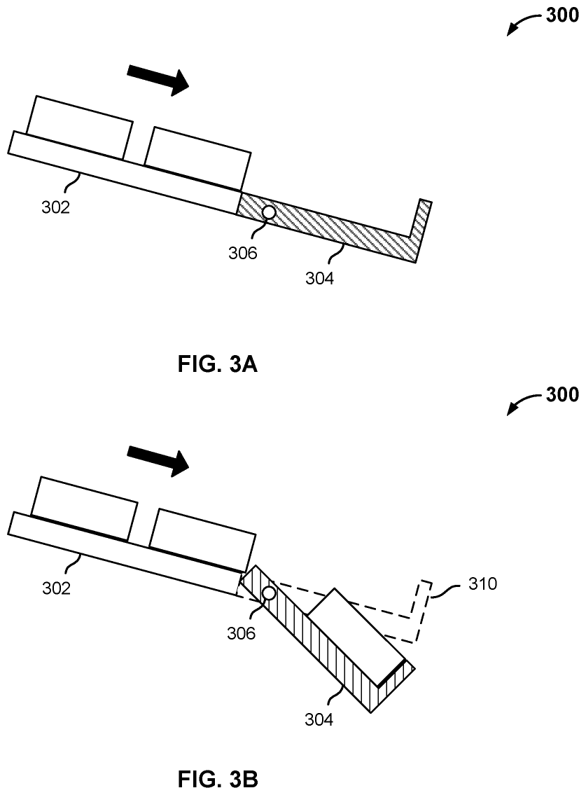

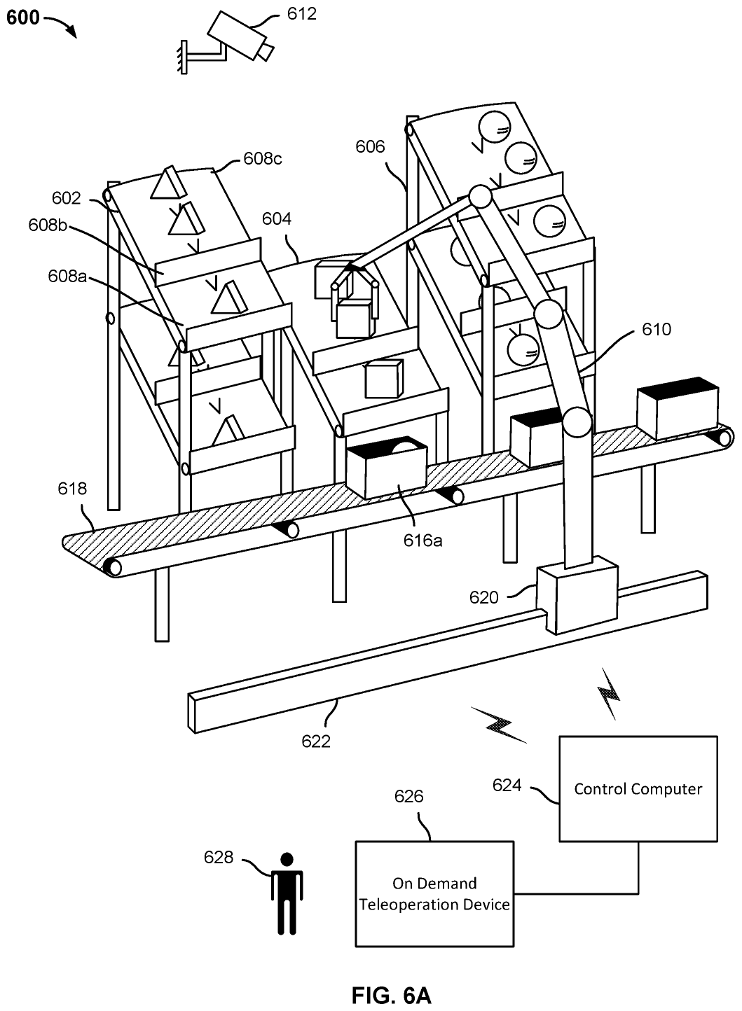

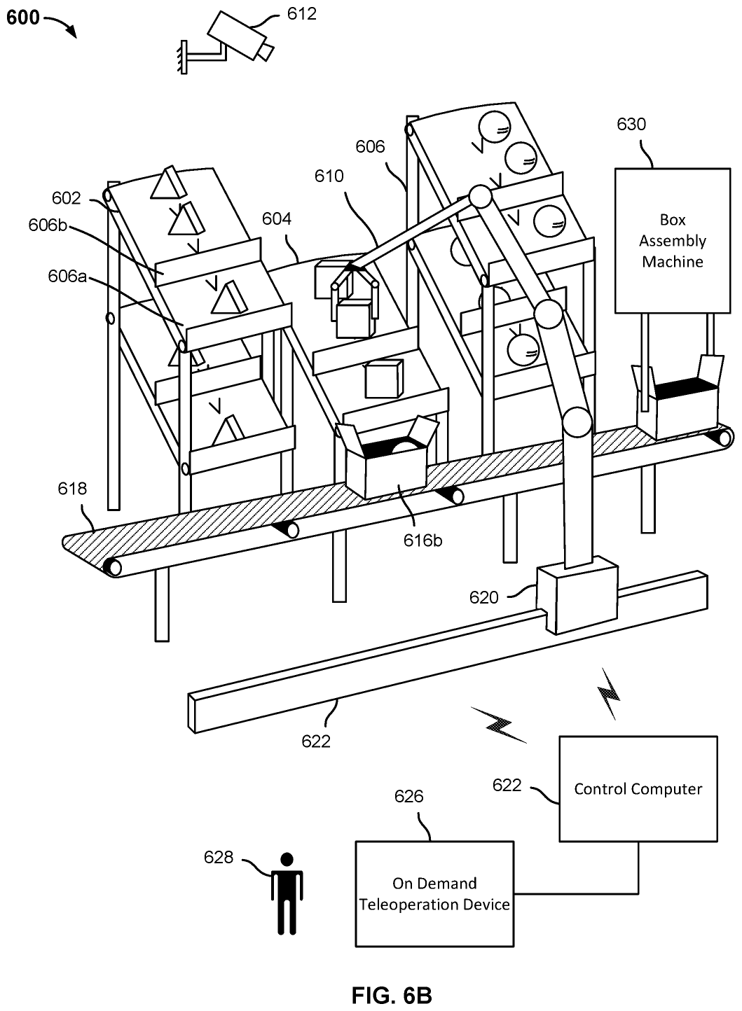

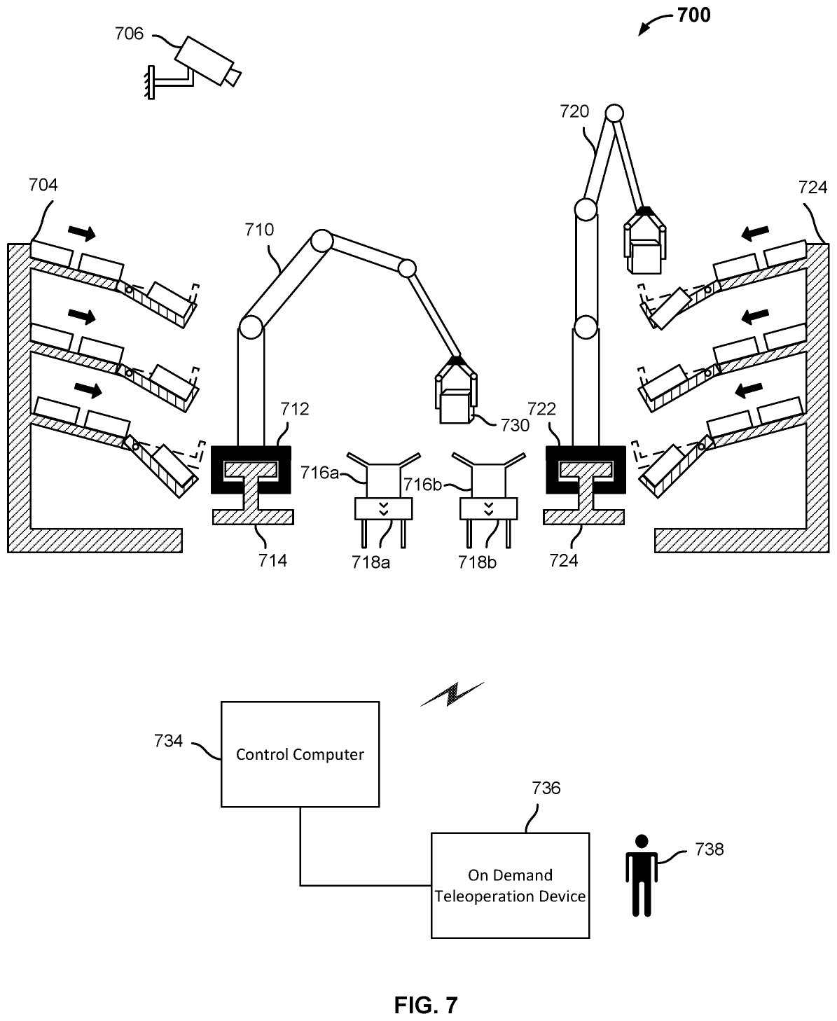

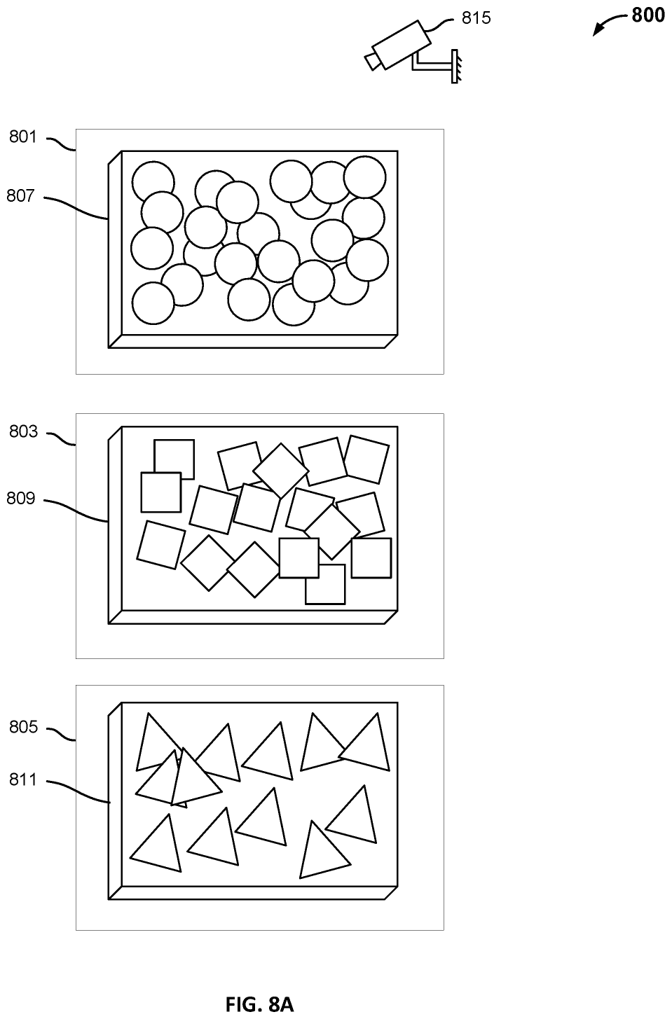

FIG. 3A is a diagram illustrating a shelf system according to various embodiments. FIG. 3B is a diagram illustrating a shelf system according to various embodiments. According to various embodiments, shelf system 300 may be implemented by kitting system 100 of FIG. 1, kitting system 200 of FIGS. 2A and 2B, kitting system 600 of FIGS. 6A and 6B, and kitting system 700 of FIG. 7.

Shelf system 300 is similar to the corresponding shelf system illustrated in FIGS. 2A and 2B. For example, as illustrated in FIGS. 3A and 3B illustrate presentation face 304 oriented in an empty position and an occupied position. Presentation face 304 may rotate around an axis such as an axis defined by gate structure 306. In the example illustrated in FIG. 3A, presentation face 304 is oriented in an empty position (as denoted by 310 in FIG. 3B). Conversely, in the example illustrated in FIG. 3B, presentation face 304 is oriented in an occupied position (e.g., an item is disposed on presentation face 304).

In various embodiments, when presentation face is in the occupied position, the extent of a wrist flexion required to engage an end effector with the item on the presentation face (in manner that the end effector engages the item orthogonal a surface of the item) is less than a wrist flexion required if the item were disposed on the presentation face when the presentation is oriented in the empty position 310. In some embodiments, a robotic arm uses a wrist extension movement to engage the item when presentation face is oriented in the occupied position; and the robotic arm would be required to use a wrist flexion movement to engage the item when presentation face is oriented in the empty position.

As illustrated in FIGS. 3A and 3B, items are conveyed from feeder portion 302 to presentation face 304 (e.g., when gate structure 306 is in an open position). When an item is on the presentation face 304, the gate structure 306 moves to a closed position according to which conveyance of the items on the feeder portion 302 is blocked (e.g., by a part of presentation face 304). The gate structure 306 may be biased to return presentation face 304 to the empty position in response to the item being removed from presentation face 304.

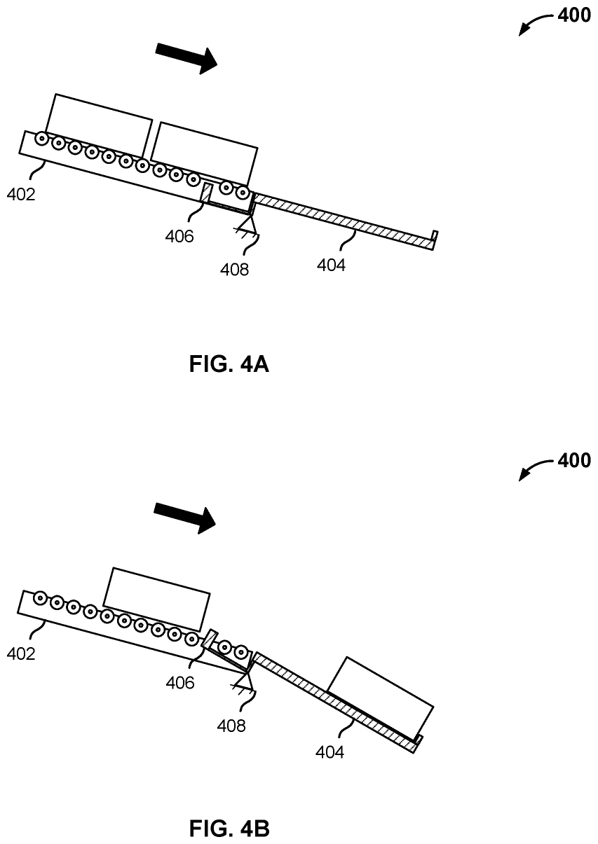

FIG. 4A is a diagram illustrating a shelf system according to various embodiments. FIG. 4B is a diagram illustrating a shelf system according to various embodiments. According to various embodiments, shelf system 400 may be implemented by kitting system 100 of FIG. 1, kitting system 200 of FIGS. 2A and 2B, kitting system 600 of FIGS. 6A and 6B, and kitting system 700 of FIG. 7.

As illustrated in FIGS. 4A and 4B illustrate presentation face 404 oriented in an empty position and an occupied position (e.g., an item is disposed on presentation face 404 in FIG. 4B). The gate structure 406 may integrated with presentation face 404. For example, as illustrated in FIGS. 4A and 4B, presentation face 404 rotates around an axis such that when the presentation face 404 has an item disposed thereon, gate structure 406 is moved to block conveyance/flow of items from feeder portion 402 to presentation face 404. The feeder portion 402 may be configured to have a space/gap through which the gate structure 406 is moved to retract/extend based on whether the gate structure 406 is in a closed position or an open position.

Presentation face 404 may rotate around an axis based at least in part on whether an item is disposed on the presentation face 404. In the example illustrated in FIG. 4A, presentation face 404 is oriented in an empty position. Conversely, in the example illustrated in FIG. 4B, presentation face 404 is oriented in an occupied position (e.g., an item is disposed on presentation face 404).

In various embodiments, when presentation face is in the occupied position, the extent of a wrist flexion required to engage an end effector with the item on the presentation face (in manner that the end effector engages the item orthogonal a surface of the item) is less than a wrist flexion required if the item were disposed on the presentation face when the presentation is oriented in the empty position. In some embodiments, a robotic arm uses a wrist extension movement to engage the item when presentation face is oriented in the occupied position; and the robotic arm would be required to use a wrist flexion movement to engage the item when presentation face is oriented in the empty position.

As illustrated in FIGS. 4A and 4B, items are conveyed from feeder portion 402 to presentation face 404 (e.g., when gate structure 406 is in an open position). When an item is on the presentation face 404, the gate structure 406 moves to a closed position according to which conveyance of the items on the feeder portion 402 is blocked (e.g., by a part of gate structure 406 extending through a gap/space in the feeder portion).

In some embodiments, the gate structure 406 is a counterweight that is sufficient to return the gate structure to an open position when the weight on the presentation face 404 is below a threshold weight (e.g., when an item is removed from the presentation face 404). In response to the item being removed from the presentation face 404, the weight of the gate structure rotates to an open position and the presentation face 406 may be positioned in a manner for items to convey from feeder portion 402 to presentation face 404. In addition, or alternatively, the gate structure 406 and/or the presentation face 404 may be biased to return presentation face 404 to the empty position in response to the item being removed from presentation face 404. In some embodiments, the presentation face is biased by a biasing mechanism such as a torsional spring or the like. The biasing mechanism may bias the presentation face 404 to return presentation face 404 to the empty position in response to the item being removed from presentation face 404. The presentation face 404 may pivot around a defined point or axis. For example, shelf system 400 may include fulcrum 408 or the like such as a hinge, etc.

In some embodiments, the feeder portion 402 comprises a roller conveyor comprising one or more rollers that support and/or help guide items from the feeder portion 402 to the presentation face 406. As an example, the conveyance of the item (e.g., along the feeder portion and/or from the feeder portion to the presentation face) may be passive such as via gravity acting on an item disposed on the feeder portion (e.g., in the case that the feeder portion is configured to tilt towards the presentation face). As another example, the conveyance of the item may be at least partially active based on the feeder portion being configured with a conveyor that is driven by a motor or the like and that carries an item from an input location of the feeder portion to the presentation face. In various embodiments, the feeder portion configured to receive a succession of items on a receiving end (e.g., an input to the feeder portion) and convey the items to a destination end (e.g., an end that is operatively connected/coupled to a presentation face or that otherwise exits the feeder portion to the applicable presentation face). The succession of items may be manually loaded to the feeder portion 402 or kitting shelf system (e.g., via a human operator), or the succession of items may be automatically loaded to the feeder portion (e.g., via a robotic arm/component, or based at least in part on the feeder portion being coupled to a chute that conveys items from a source flow/pile).

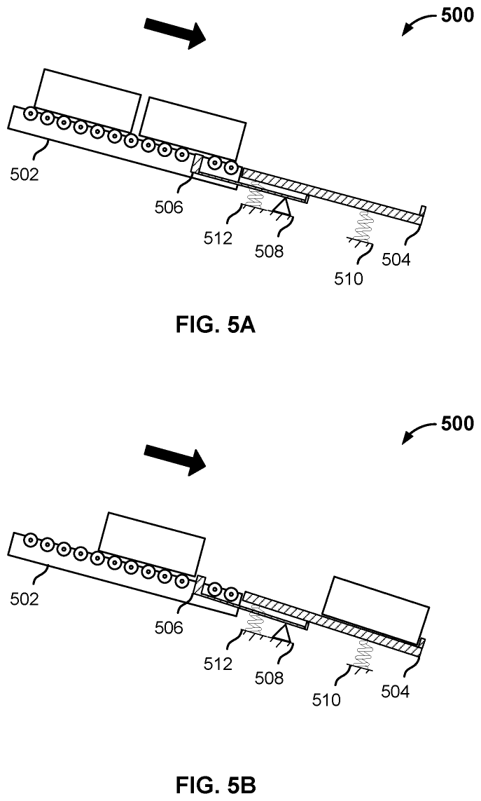

FIG. 5A is a diagram illustrating a shelf system according to various embodiments. FIG. 5B is a diagram illustrating a shelf system according to various embodiments. According to various embodiments, shelf system 500 may be implemented by kitting system 100 of FIG. 1, kitting system 200 of FIGS. 2A and 2B, kitting system 600 of FIGS. 6A and 6B, and kitting system 700 of FIG. 7.

As illustrated in FIGS. 5A and 5B illustrate presentation face 504 oriented in an empty position and an occupied position (e.g., an item is disposed on presentation face 504 in FIG. 5B). The gate structure 506 may integrated with presentation face 504. For example, as illustrated in FIGS. 5A and 5B, presentation face 504 rotates around an axis such that when the presentation face 404 has an item disposed thereon, gate structure 506 is moved to block conveyance/flow of items from feeder portion 502 to presentation face 504. In some embodiments, presentation face 504 rotate around an axis defined by fulcrum 508 or the like such as a hinge, etc. The feeder portion 502 may be configured to have a space/gap through which the gate structure 506 is moved to retract/extend based on whether the gate structure 506 is in a closed position or an open position.

Presentation face 504 may rotate around an axis based at least in part on whether an item is disposed on the presentation face 504. In the example illustrated in FIG. 5A, presentation face 504 is oriented in an empty position. Conversely, in the example illustrated in FIG. 4B, presentation face 504 is oriented in an occupied position (e.g., an item is disposed on presentation face 404). In response to an item being moved to the presentation face 504, presentation face 504 rotates around fulcrum 508 (e.g., based at least in part on the weight of the item that has moved to presentation face 504).

In various embodiments, when presentation face is in the occupied position, the extent of a wrist flexion required to engage an end effector with the item on the presentation face (in manner that the end effector engages the item orthogonal a surface of the item) is less than a wrist flexion required if the item were disposed on the presentation face when the presentation is oriented in the empty position. In some embodiments, a robotic arm uses a wrist extension movement to engage the item when presentation face is oriented in the occupied position; and the robotic arm would be required to use a wrist flexion movement to engage the item when presentation face is oriented in the empty position.

As illustrated in FIGS. 5A and 5B, items are conveyed from feeder portion 502 to presentation face 504 (e.g., when gate structure 506 is in an open position). When an item is on the presentation face 504, the gate structure 506 moves to a closed position according to which conveyance of the items on the feeder portion 502 is blocked (e.g., by a part of gate structure 506 extending through a gap/space in the feeder portion). The gate structure 506 and/or the presentation face 504 may be biased to return presentation face 504 to the empty position in response to the item being removed from presentation face 504.

In some embodiments, the feeder portion 502 comprises a roller conveyor comprising one or more rollers that support and/or help guide items from the feeder portion 502 to the presentation face 506. As an example, the conveyance of the item (e.g., along the feeder portion and/or from the feeder portion to the presentation face) may be passive such as via gravity acting on an item disposed on the feeder portion (e.g., in the case that the feeder portion is configured to tilt towards the presentation face). As another example, the conveyance of the item may be at least partially active based on the feeder portion being configured with a conveyor that is driven by a motor or the like and that carries an item from an input location of the feeder portion to the presentation face. In various embodiments, the feeder portion configured to receive a succession of items on a receiving end (e.g., an input to the feeder portion) and convey the items to a destination end (e.g., an end that is operatively connected/coupled to a presentation face or that otherwise exits the feeder portion to the applicable presentation face). The succession of items may be manually loaded to the feeder portion 402 or kitting shelf system (e.g., via a human operator), or the succession of items may be automatically loaded to the feeder portion (e.g., via a robotic arm/component, or based at least in part on the feeder portion being coupled to a chute that conveys items from a source flow/pile).

In various embodiments, gate structure 506 is biased to be in an open position and/or presentation face 502 is biased to an orientation corresponding to the empty position. For example, shelf system 500 includes one or more of first biasing element 510. The first biasing element 510 may be a spring that exerts a force on the presentation face 504 (e.g., to bias presentation face 504 to rotate around the axis defined by fulcrum 508 and to move the presentation face 504 to the empty position). In some embodiments, shelf system 500 includes second biasing element 512. As an example, second biasing element 512 may bias one or more of the gate structure 506 to the closed position and/or the presentation face 504 to the occupied position. According to various embodiments, the biasing force exerted by first biasing element 510 may be greater than the biasing force exerted by the second biasing element 512 such that the shelf system is biased for gate structure 506 is biased to be in an open position and/or for presentation face 502 is biased to an orientation corresponding to the empty position. When an item is moved to be disposed on the presentation face 504, the combination of the weight of the item and the biasing force of second biasing element 512 may be greater than a counter-acting biasing force of the first biasing element 510. Accordingly, when an item is disposed on the presentation face 504, the gate structure 506 is moved to the closed position and/or the presentation face 504 is moved to be oriented in the occupied position. Although the example illustrated in FIGS. 5A and 5B illustrate the first biasing element 510 and the second biasing element 512 as being springs, various elements for exerting a bias (e.g., a biasing force) may be implemented. The biasing elements may be a spring mechanism, a pneumatic piston, and the like.

According to various embodiments, movement of the presentation face 504 and/or gate structure 506 is dampened by a dampening element. As an example, the dampening element may include one or more first biasing element 510 and second biasing element 512. The movement may be dampened to prevent/inhibit dislodging of an item from presentation face 504 (e.g., as the presentation face 504 moves to the occupied position), and/or from the feeder portion 502. Various dampening elements may be implemented in the shelf system in connection with dampening movement of the presentation face 504 and/or gate structure 506 is dampened by a dampening element.

FIG. 6A is a diagram illustrating a kitting system according to various embodiments. According to various embodiments, kitting system 100 may implement shelf system 300 of FIGS. 3A and 3B, shelf system 400 of FIGS. 4A and 4B, and/or shelf system 500 of FIGS. 5A and 5B.

As illustrated in FIG. 6A, in various embodiments a kitting system 600 includes one or more kitting shelf systems (e.g., kitting shelf system 602, kitting shelf system 604, and/or kitting shelf system 606). In the case of kitting system 600 including a plurality of kitting shelf systems, the kitting shelf systems may be disposed along one side of a conveyor (e.g., conveyor 618), or the kitting shelf systems may be disposed on different sides of the conveyor.

In various embodiments, a kitting system 600 includes one or more robotic arms (e.g., robotic arm 610). In the case of kitting system 600 including a plurality of robotic arms, the robotic arms may be disposed along one side of a conveyor (e.g., conveyor 618), or the robotic arms may be disposed on different sides of the conveyor. Further, a robotic arm may be disposed on a same side of the conveyor as one or more kitting shelf systems, or the robotic arm may be disposed on a side of the conveyor that is opposite to the one or more kitting shelf systems. In various embodiments, in the case of kitting system 600 including a plurality of robotic arms, a robotic arm is selected from among the plurality of robotic arms to obtain an item (or object from within an item) from a kitting shelf system based on a location of the robotic arm, an effectiveness of the particular robotic arm successfully picking the item (e.g., a computed likelihood of success), a reach of the particular robotic arm, a time within which the particular robotic arm will complete the picking and placing of the item, etc. The particular robotic arm selected to pick and place the item may be selected by control computer 624. For example, control computer 624 may store a model with respect to the workspace of kitting system 600 and/or one or more of the robotic arms within the workspace. The control computer may use the model to determine a robotic arm to pick and place an item, and/or a robotic arm to pick and place each of one or more items for a particular order (e.g., a single robotic arm may be used to kit the items for an order). In some embodiments, a robotic arm that is disposed on a same side as a kitting shelf system is more effective/efficient at picking and placing items from shelves on the kitting shelf system that are above a threshold height. For shelves below the threshold height, the contortion of the robotic arm required to reach an item on such shelves renders the robotic arm on the same side of the conveyor as the particular kitting shelf system inefficient. Further, the contortion of the robotic arm required to reach an item on such shelves renders the robotic arm with limited range/mobility with which to pick an item from a shelf below the height threshold. Accordingly, in cases of items on shelves below a threshold height, kitting system 600 may use a robotic arm 610 on a side of the conveyor 618 that is opposite to the kitting shelf system from which the item is to be obtained.

Kitting shelf system 602 includes one or more shelves. In some embodiments, the one or more shelves respectively include one or more items disposed thereon. Different shelves within kitting shelf system 602 may include different items (e.g., a different type of item, items having one or more different identifiers such as serial numbers, model numbers, lot numbers, or the like). One or more of the kitting shelf system(s) may have a feeder portion, a gate structure, and a presentation face similar to those disclosed with respect to shelf system 300 of FIGS. 3A and 3B, shelf system 400 of FIGS. 4A and 4B, and/or shelf system 500 of FIGS. 5A and 5B. As illustrated in FIG. 6A, the kitting shelf system comprises a shelf having a presentation face 608a, a gate structure 608b, and a feeder portion 608c.

In some embodiments, robotic arm 610 is movable with respect to one or more of kitting shelf systems 602, 604, and 606 and/or with respect to a conveyor (e.g., conveyor 618) or other location at which a receptacle is disposed. In the example shown in FIG. 6A, robotic arm 610 is mounted on carriage 620, which is configured to ride along a rail or other linear guide 622 disposed alongside and substantially parallel to the conveyor 618, on a side opposite the kitting shelf system 602. In various embodiments, a motor, belt, chain, or other source of motive force is applied via a controller (not shown in FIG. 6A) to move the carriage 620 and attached robotic arm 610 along the rail or guide 622 to facilitate the automated retrieval of items from one or more kitting shelf systems, and the placement of items in receptacle 616a (e.g., a box, a tray, etc.) as the receptacle 616a is moved along conveyor 618. Control of robotic arm may be coordinated based at least in part on one or more items to be picked and placed in receptacle 616a, a location of receptacle 616a, and/or a path of receptacle 616a (e.g., based on a determined movement and/or speed of conveyor 618).

In some embodiments, kitting system 600 includes control computer 624. In the example shown, operation of kitting shelf system 602, conveyor 618; and robotic arm 610, and/or carriage 620 are operated in a coordinated manner under the control of control computer 624. In the example shown, control computer 624 is in communication (e.g., wireless communication) with controllers, not shown in FIG. 6A, each configured to control operation of a corresponding element comprising kitting system 600, e.g., one or more of kitting shelf systems 602, 604, and/or 606; robotic arm 610, conveyor 618, carriage 610, and/or receptacle source (not shown). Although wireless connections are shown in FIG. 6A, in various embodiments wired connections or a combination of wired and wireless connections may be used.

In the example shown in FIG. 6A, robotic arm 610 has an end effector corresponding to a two-digit gripper. In various embodiments, robotic arm 610 includes one or more other and/or different types of end effectors/retrieval tool, including without limitation a gripper having three or more digits; a gripper having digits with different attributes than as shown, e.g., cushioned digits, smaller digits, larger digits, etc.; and/or a retrieval tool that is not a gripper, such as one configured to pick up items using suction, friction, electrostatic force, magnetic force, etc. In some embodiments, the gripper of robotic arm 610 may be interchanged with one or more different end effectors, depending on one or more attributes of an item to be retrieved, e.g., weight, fragility, compressibility, rigidity, size, shape, etc. In some embodiments, the gripper of robotic arm 610 may be used to retrieve and use different end effectors (e.g., gripper-held tools) to pick and place items, depending on one or more attributes of the item to be retrieved, for example. One or more attributes of the items may be determined based at least in part on information obtained from one or more sensors such as camera 612.

In various embodiments, control computer 624 is configured, e.g., by software running on control computer 624, to receive data associated with an invoice, order, part list, pick list, or other list of items to be retrieved and packed together; determine a strategy/plan to fulfill the retrieve and pack the required items; and operate elements of kitting system 600, e.g., kitting shelf system 602, 604, and/or 606; conveyor 618; and robotic arm 610 and/or carriage 620, in coordination to fulfill the requirement(s). In some embodiments, kitting system 600 includes a plurality of kitting shelf systems and/or a plurality of robotic arms, and one or more control computers are controlled to coordinate/operate elements of kitting system 600.

For example, in some embodiments, control computer 624 is configured to receive a list of items to be packed. Control computer 624 determines which items are associated with which of kitting shelf systems (or which items are associated with a particular shelf of a kitting shelf system such as kitting shelf system 602) and makes a plan to retrieve and pack the items. In some embodiments, computer 624 controls a box assembly machine (not shown) or a receptacle source module, and deposit a receptacle on conveyor 618 and controls the conveyor 618 to advance the receptacle to a position to be loaded with a first one or more items. The control computer 624 controls the carriage 620 and/or robotic arm 610 as needed to position the robotic arm 610 to retrieve the first one or more items from the associated a kitting shelf system (or a shelf of kitting shelf system 602). Control computer 624 may control kitting shelf system 602, 604, and/or 606, e.g., to ensure the require item(s) in the required quantities are present in the pickup zone (e.g., a presentation face) at the end of kitting shelf system 602, 604, and/or 606 (or a shelf of the kitting shelf system) nearest to the conveyor 618 and robotic arm 610. Control computer 624 controls robotic arm 610 to retrieve the item(s) from the corresponding pickup zone(s) and places the item(s) in the receptacle (e.g., receptacle 616a) before moving on to perform coordinated retrieval and packing of any further items required to be included in that particular kit. In response to a determination that all items have been retrieved and packed (e.g., according to a plan for kitting one or more items), control computer 624 controls conveyor 618 to advance the receptacle (e.g., receptacle 616a) to a next stage of fulfillment, not shown in FIG. 6A (e.g., a station at which the box is sealed, labeled, and sent to be shipped).

In the example shown in FIG. 6A, kitting shelf system 602 comprises angled shelves or angled conveyors (e.g., shelf comprising presentation face 608a, gate structure 608b, and feeder portion 608c) that are configured to be loaded, e.g., by human workers, robots, and/or other machines, or some combination thereof, from a back end (upper/left as shown in FIG. 6A). The kitting shelf system 602 may be loaded at the feeder portion or in a loader element (e.g., a chute) that conveys items to the respective feeder portions of the shelves. Items may be scanned, recognized by computer vision, etc. to determine and store on control computer 624 data associating the item and/or item type or other items attributes associated with each kitting shelf system. In various embodiments a mix of different types of kitting shelf systems may be included in a kitting system such as system 600. For example, the items shown in FIG. 6A as being supplied via kitting shelf system 602 may be supplied in some embodiments via a stationary ramp down which the items are rolled. In some embodiments, a kitting shelf system may comprise any one of a plurality of structures and mechanisms to supply items to an associated pick zone, including without limitation a gravity type conveyor having a plurality of adjacent rollers, a ramp, a conveyor belt, a set of revolving bins, etc.

In some embodiments, kitting shelf system 602 comprises one or more gating mechanisms that control conveyance of items to or within angled shelves or angled conveyors (e.g., gate structure 608b). The one or more gating mechanisms may control the conveyance of one or more items to one or more presentation faces (e.g., presentation face 608a) of the kitting shelf system in connection with the kitting of the one or more items (e.g., retrieval of the item(s) by a robotic arm and placement of the item(s) into a corresponding receptacle(s)). The one or more gating mechanisms may be controlled by control computer 624 or the one or more gating mechanisms may be configured to operate mechanically (e.g., without intervention by a control computer). In various embodiments, the one or more gating mechanisms control conveyance of the one or more items based at least in part on a plan (e.g., a predetermined plan for kitting an item based at least in part on an order).

In various embodiments, kitting system 600 is initialized by having control computer 624 determine through automated processing, manual configuration, and/or a combination thereof the placement, type, capabilities, etc. of each kitting shelf system (e.g., kitting shelf system 602, 604, and/or 606) and the item(s) associated with each kitting shelf system. In addition, elements of kitting system 600 may register with the control computer 624. Registration may include admitting an element, such as each of the kitting shelf system, to a control network. In some embodiments, operational tests may be performed. For example, control computer 624 may test an ability to control a newly-registered element, such as by operating the conveyor belt of a kitting machine, such as kitting shelf system 602, in the forward and back directions, at various speeds, etc.

In various embodiments, elements of kitting system 600 may be added, removed, swapped out, etc. In such an instance, control computer 624 initializes and registers the new element, performs operational tests, and begins/resumes kitting operations, incorporating the newly added element, for example.

Referring further to FIG. 6A, in the example shown kitting system 600 includes a camera 612 (e.g., a video camera) configured to capture images (e.g., video images) of the elements comprised in kiting system 600. Camera 612 may be one of a plurality of sensors that obtains information pertaining to the workspace (e.g., the workspace corresponding to kitting system 600). For example, camera 612 may be one of a plurality of sensors used by control computer 624 to control the elements comprising kitting system 100. For example, in the example shown, video generated by camera 612 and sent to control computer 624 may be used by control computer 624 to control the speed and/or direction of the conveyor belts comprised in the kitting shelf system 102 and/or a gating mechanism (e.g., 608b) in the kitting shelf system 602 to ensure a sufficient and not excessive number of items are available in the pickup zone (e.g., a presentation face 608a of kitting shelf system 602) and/or to position or reposition the items for retrieval by robotic arm 610. In addition, camera 612 and/or other cameras and/or other sensors may be used to facilitate robotic arm 610 picking up an item and/or placing the item in its receptacle (e.g., box). In various embodiments, a plurality of cameras may be deployed in a number of locations, including in the environment and on the respective elements comprising system 600, to facilitate automated (and, if needed, human assisted) kitting operations. In various embodiments, sensors other than cameras may be deployed, including without limitation contact or limit switches, pressure sensors, weight sensors, and the like.

In various embodiments, one or more sensors (e.g., camera 612) is used to capture information pertaining to items associated with kitting shelf system 602, 605, and/or 606. For example, camera 612 may capture an image of one or more items on a shelf. As another example, if an item on a shelf is a tray or other receptacle, camera 612 may capture information pertaining to objects within the tray. Control computer 624 may use information pertaining to the workspace to determine a plan, and/or to control operation of robotic arm 610 to pick an item (or an object from within the item) from kitting shelf system 602. Control computer 624 may use the information pertaining to the workspace in connection with determining a location of an object within a tray on a shelf; a quantity of objects within the tray; a type of object within the tray; an orientation of one or more objects within the tray; etc.

In various embodiments, control computer 624 is programmed to determine a plan to fulfill a kitting requirement based at least in part on a model of the robotic arm 610 and other elements comprised in kitting system 600, e.g., kitting shelf system 602, 604, and/or 606; conveyor 618; a receptacle source module (e.g., a box assembly machine) (not shown); robotic arm 610; and/or carriage 620. The respective models in various embodiments reflect capabilities and limitations of each respective element. For example, the shelves of kitting shelf system 602, 604, and/or 606 are in fixed positions in this example, but each has a conveyor belt which may be capable of being moved in forward and back directions and/or at different speeds. In addition, the control computer 624 may use information stored in connection with initialization and/or configuration, e.g., which items are on which location(s) on which kitting shelf system (or on which shelf of which kitting shelf system), where each kitting shelf system and/or its associated pick up zone (e.g., presentation face(s)) is located, etc., to determine a plan to fulfill a requirement. In addition, control computer 624 may use data determine based at least in part on sensor data, such as video captured by camera 612, to make a plan to fulfill a requirement.

According to various embodiments, kitting of items from one or more kitting shelf systems is improved through use of a dynamic kitting method or system that determines a path or trajectory for kitting of an item using one or more of an attribute of the item to be singulated and an attribute of another item within the workspace (e.g., an item and/or receptacle on the conveyor). The dynamic kitting method or system may include an updating of the path or trajectory for kitting of an item in response detecting one or more of an attribute of the item to be kitted and an attribute of another item within the workspace (e.g., an item on the conveyor). The dynamic kitting method or system may include an updating of the conveyance of an item from a feeder portion of a kitting shelf system to a presentation face of the kitting shelf system in connection with kitting of an item (or object from an item on the kitting shelf system) in response to determining an attribute of the workspace. The attribute of the workspace used in connection with updating the plan for kitting the item/object may include an attribute of an item/object to be kitted, a quantity of objects within an item (e.g., a tray on a kitting shelf system), a speed of the conveyor, a characteristic associated with a receptacle on the conveyor, an orientation of the item on the kitting shelf system, an orientation of a presentation face of the kitting shelf system, etc. In some embodiments, the kitting system 600 (e.g., control computer 624) dynamically updates the plan for kitting the item during kitting based on a context of the workspace (e.g., a state or condition of the item, a property of the item, another item within the workspace, a speed of conveyor 618, an identifier of receptacle 616, etc.).

In various embodiments, control computer 624 is configured to formulate and/or update or reformulate a plan to fulfill a requirement, and to implement or attempt to implement the plan, by employing strategies to do a (next) task or subtask that have been programmed into and/or learned by control computer 624. Examples include, without limitation, strategies to use robotic arm 610 to pick up a given item (or an object from an item on a presentation face of a kitting shelf system) based on attributes of the item (rigidity, fragility, shape, orientation, etc.). In some embodiments, control computer 624 is programmed to use a first (e.g., preferred or best) strategy to attempt to perform a task (e.g., pick up an item with robotic arm 610), and if the first strategy fails then to determine and use an alternate strategy, if one is available (e.g., use the robotic arm 610 to nudge the item (or object) then try again, operate the conveyor or other instrumentality of the kitting shelf system 602, 604, and/or 606 (or of a shelf of kitting shelf system), forward and/or backward a bit and try again, etc.). The preferred or best strategy can be determined based at least in part on a model associated with a likelihood of successful picking and placing the object, etc.

In the example shown in FIG. 6A, control computer 624 is connected to an on demand teleoperation device 626 operated by a human operator 628. While in FIG. 6A teleoperation device 626 is operated by a human operator 128, in some embodiments teleoperation device 626 may be operated by a non-human operator, such as a highly skilled robot. In various embodiments, control computer 624 is configured to invoke on demand teleoperation based at least in part on a determination by control computer 624 that control computer 624 does not have an available strategy to continue/complete a kitting operation and/or a component task thereof through fully automated operation. For example, an item is dropped in a location from which the robotic arm 610 cannot retrieve the item; or, an item has been attempted to be picked up a prescribed maximum number of attempts and has not successfully been retrieved; operation of and end effector deviates from a defined normal operation (e.g., if a suction cup is broken), etc. Based on such a determination, control computer 624 sends an alert or other communication to on demand teleoperation device 626, prompting human operator 628 to use teleoperation device 626 to operate one or more elements of kitting system 600—e.g., one or more of kitting shelf system 602, 604, and/or 606 (or shelf); conveyor 618; a receptacle source module (e.g., a box assembly machine) (not shown); robotic arm 610; and/or carriage 618—to perform at least the task or subtask the kitting system 600 was not able to complete under fully automated control by control computer 624.

FIG. 6B is a diagram illustrating a kitting system according to various embodiments. As illustrated in FIG. 6B, kitting system 600 can be further configured with a receptacle source such as box assembly machine 630. According to various embodiments, the receptacle source places an empty receptacle onto conveyor 618. The receptacle source may obtain the empty receptacle from an inventory of empty receptacles. In some implementations, the receptacle source assembles the empty receptacles (e.g., assembles the box). In some embodiments, the receptacle source places the empty receptacles on the conveyor based at least in part on a predetermined location, the speed of the conveyor 618, a distance between a previous receptacle and the empty receptacle being placed, an order for which the items are being kitted (e.g., receptacles pertaining to a particular order may be placed closer together than receptacles pertaining to different orders), a size of the empty receptacle and/or the previous receptacle, etc.

As illustrated in FIGS. 6A and 6B, the receptacle may be a tray such as receptacle 616a, or a box such as receptacle 616b. Various types of receptacles may be implemented.

FIG. 7 is a diagram illustrating a kitting system according to various embodiments.

According to various embodiments, a kitting system may include one or more kitting shelf systems, one or more robotic arms, and/or one or more conveyors. The kitting system may include one or more control computers that are configured to control operation of the kitting shelf system(s), the robotic arm(s), and/or the conveyor(s). The one or more kitting shelf systems, one or more robotic arms, and/or one or more conveyors may be variously arranged. In the example illustrated in FIG. 7, kitting system 700 includes kitting shelf system 704 and kitting shelf system 724; robotic arm 710 and robotic arm 720; and conveyors 718a and 718b. In some implementations, kitting system has a plurality of kitting shelf systems, a plurality or robotic arms, and a single conveyor (along which receptacles flow during a kitting process).

In various embodiments, the one or more conveyors of the kitting system 700 may be arranged in various configurations. The conveyor can be arranged in a straight line (e.g., from an entrance of kitting system 700 or section of a warehouse, to an exit of the kitting system 700 or section of the warehouse); an “L”-shape; a “U” shape,

In the case of kitting system 700 including a plurality of robotic arms, the robotic arms may be disposed along one side of a conveyor (e.g., conveyor 718a), or the robotic arms may be disposed on different sides of the conveyor(s). Further, a robotic arm may be disposed on a same side of the conveyor as one or more kitting shelf systems, or the robotic arm may be disposed on a side of the conveyor that is opposite to the one or more kitting shelf systems. In various embodiments, in the case of kitting system 700 including a plurality of robotic arms, a robotic arm is selected from among the plurality of robotic arms to obtain an item (or object from within an item) from a kitting shelf system based on a location of the robotic arm, an effectiveness of the particular robotic arm successfully picking the item (e.g., a computed likelihood of success), a reach of the particular robotic arm, a time within which the particular robotic arm will complete the picking and placing of the item, etc. The particular robotic arm selected to pick and place the item may be selected by control computer 734. For example, control computer 724 may store a model with respect to the workspace of kitting system 700 and/or one or more of the robotic arms within the workspace. The control computer may use the model to determine a robotic arm to pick and place an item, and/or a robotic arm to pick and place each of one or more items for a particular order (e.g., a single robotic arm may be used to kit the items for an order). In some embodiments, a robotic arm that is disposed on a same side as a kitting shelf system is more effective/efficient at picking and placing items from shelves on the kitting shelf system that are above a threshold height. For shelves below the threshold height, the contortion of the robotic arm required to reach an item on such shelves renders the robotic arm on the same side of the conveyor as the particular kitting shelf system inefficient. Further, the contortion of the robotic arm required to reach an item on such shelves renders the robotic arm with limited range/mobility with which to pick an item from a shelf below the height threshold. Accordingly, in cases of items on shelves below a threshold height, kitting system 700 may use a robotic arm 710 on a side of the conveyor 718a or 718b that is opposite to the kitting shelf system 724 from which the item is to be obtained.

According to various embodiments, a kitting system may determine and/or implement a plan for kitting one or more items/objects based at least in part on information obtained by one or more sensors within the workspace. The one or more sensors may include a camera, a barcode scanner, a QR code scanner, a radio-frequency identification (RFID), a laser sensor, an infrared (IR) sensor, etc. Various other types of sensors or arrays of sensors may be implemented. One or more sensors within the workspace may obtain information (e.g., capture an image) of the workspace such as one or more shelves of a kitting shelf machine.

The kitting system may use information obtained by the one or more sensors within the workspace to determine a plan for one or more items/objects. For example, an image may be generated and an image analysis may be performed with respect to information corresponding to one or more shelves of the kitting shelf machine. One or more images may be cached such as via storing the image in a data structure associated with the kitting shelf machine, a particular shelf of the kitting shelf machine, and/or a particular item/object or type of item/object on the shelf. In some embodiments, rather than obtaining and processing information captured by the one or more sensors in connection with determining a plan for each item/object, the system may use a cached image (or information pertaining to the workspace) in connection with determining the plan.

When the kitting system determines that an item is to be kitted, the kitting system may determine whether a cached image and/or cached information pertaining to the item (e.g., an image/information for the shelf on which the item is determined to be located or for a tray in which the item/object is located, etc.). In response to determining that a cached item or cached information pertaining to the item is stored (e.g., exists), the kitting system may determine whether the kitting of a previous item is likely to have changed a state of the kitting shelf system with respect to the current item to be kitted. For example, if the kitting system determines that a previous item was picked from a first shelf, and the current item is to be picked from the second shelf, the kitting system may determine that the state of the kitting shelf system with respect to the current item has not changed (or is likely to have not changed)—the cached image with respect to an area (e.g., a tray or shelf) on which the current item is located is likely to be the same as a current image generated based on information from the one or more sensors. In response to determining that a cached image or cached information pertaining to the item is stored, a plan for kitting a current item may be determined without capturing a new image/information of the workspace and/or without performing a same level (e.g., full) image analysis with respect to such current image.

The use of the cached image or cached information pertaining to the item in connection with determining the plan to kit the item can improve the efficiency with which the kitting system (e.g., the robotic arm) may pick the item. For example, in some implementations, the image and/or information pertaining to the item/workspace that is used for determining the plan, or in connection with implementing the plan, is obtained by a sensor (e.g., a camera) mounted to the robotic arm or to a pole or other structure attached to the chassis of the robotic arm. Because the robotic arm is moving, the sensor may not be completely (or sufficiently) stabilized when the robotic arm reaches the location from which the item to be kitted is to be picked. Rather than wait for the sensor to stabilize (e.g., for a stabilization of the sensor to reach a threshold level), various embodiments may use the cached image and/or information pertaining to the item/workspace in connection with kitting the item.

In some embodiments, the determination of a change (e.g., a difference) between two images (or areas of two images such as a particular shelf or a particular tray, etc.) is computed more quickly than an image analysis of an image. For example, the computation of a difference between systems (e.g., a difference between a state of the system corresponding to when the cached image was captured, and a current state of the system) is faster than completely modelling the system (according to the current state of the system). Accordingly, if an image with respect to a workspace (e.g., an image of a shelf, an image of a tray on a shelf, etc.) is cached (e.g., before the robotic arm arrives at the shelf to pick the item therefrom), a difference between a current image and a cached image may be computed in connection with determining whether a state of the kitting shelf system with respect to the current item to be kitted, or with determining change of such state. In response to determining that the difference between the current image and the cached image is less than a threshold value (or that there is no difference between the images), then the robotic system may use the cached image in connection determining and/or implementing the plan. If an image is cached, then on a next iteration of picking an item from the kitting shelf machine (e.g., the shelf or tray on a shelf), the system can use an image point cloud to determine whether shapes in the image are in the same positions (or same relative positions) across the images. The determination of whether the shapes in the image are in the same position may be used in connection with determining whether the state of the kitting shelf system has changed or determining that the difference between the current image and the cached image is less than a threshold value (or that there is no difference between the images). In some embodiments, the determining the difference between states of the system comprises running a comparison to see if an expected object is still within an area of the image where it is expected to be. The comparison may be run on a subset of the entire cached image.

In some embodiments, an accelerometer, gyroscope, or other type of sensor may be used in connection with determining whether a sensor (e.g., a camera) is sufficiently stable to obtain the image and/or other pertaining to the workspace. For example, in the case of the camera being mounted to a pole or other structure attached to the chassis of the robot, the camera may require a certain amount of time before becoming sufficiently stable to capture an image. The kitting system may comprise an accelerometer that is used to measure the stability of the camera or the robotic arm, etc. In response to a value from the accelerometer and/or the gyroscope being less than a threshold value (e.g., vibrations being less than a threshold value), the kitting system may determine that the camera is sufficiently stable to capture the image and/or other pertaining to the workspace. In some embodiments, the value(s) from the accelerometer and/or the gyroscope may be used in connection with the processing of the image and/or other information pertaining to the workspace. For example, blurring effects in the image captured by the camera may be removed (or improved) based on an image processing using at least the value(s) from the accelerometer and/or the gyroscope.

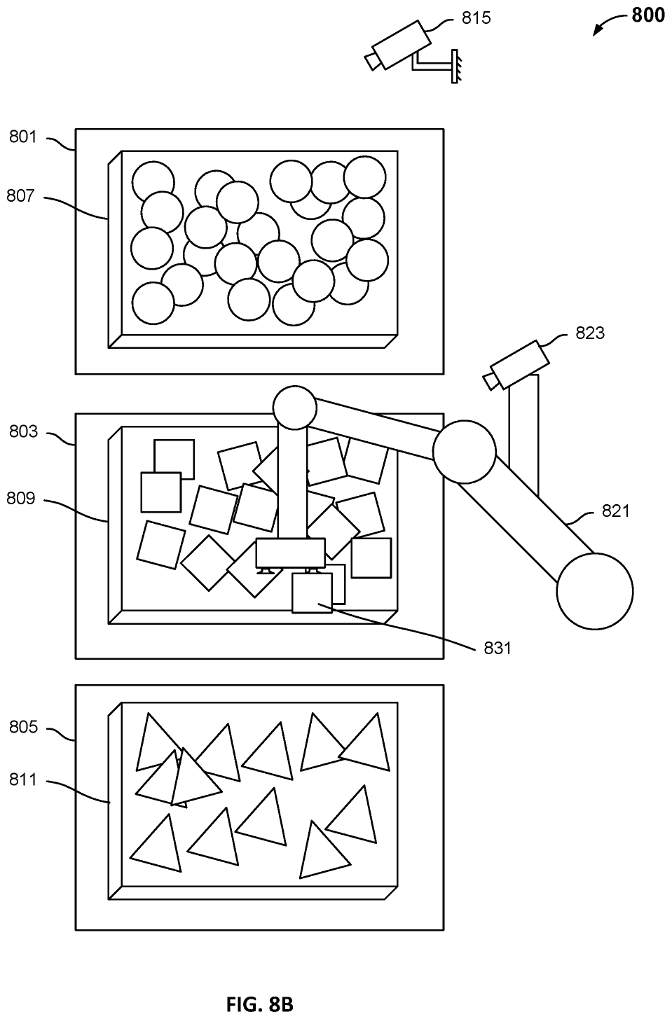

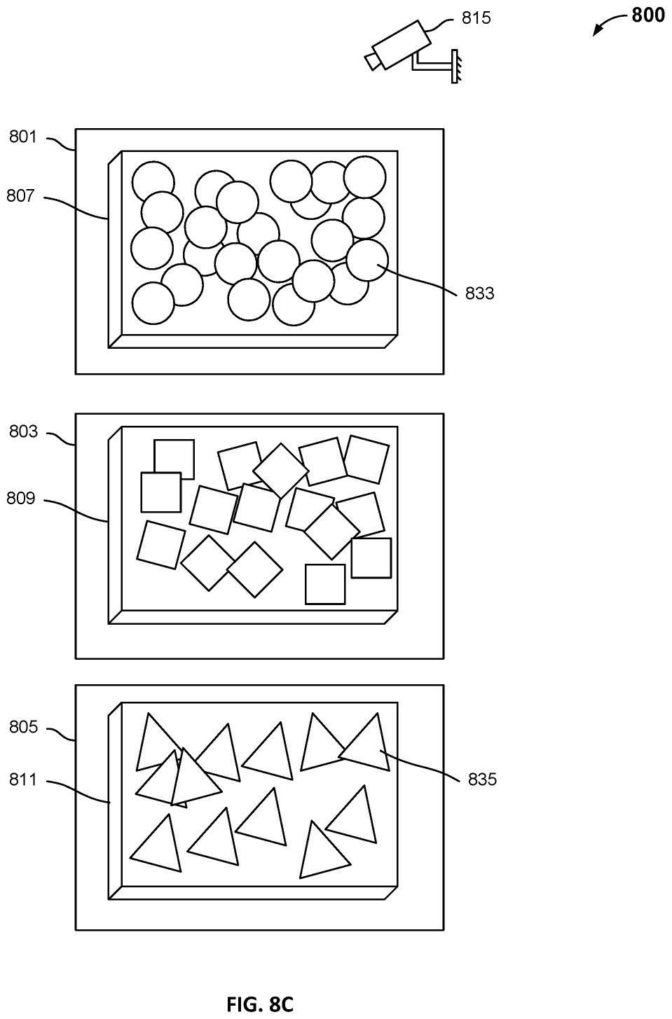

FIG. 8A-8C are diagrams illustrating a kitting system according to various embodiments. In the examples shown in FIGS. 8A-8C, system 800 comprises one or more sensors such as camera 815. The one or more sensors may obtain an image of, or information pertaining to, system 800 such as shelf 801, shelf 803, and/or shelf 805. Accordingly, the image of, or other information pertaining to, system 800 may indicate that shelf 801 comprises tray 807, shelf 803 comprises tray 809, and/or shelf 805 comprises tray 811.

In some embodiments, system 800 determines that tray 807, tray 809, and/or tray 811 comprises one or more objects. System 800 may store (e.g., cache) the image and/or the information pertaining to the workspace. As illustrated in FIG. 8B, robotic arm 821 may move to shelf 803 and pick up item 831. In some embodiments, robotic arm 821 comprises a camera 823. In connection with picking and placing item 831 from tray 809, system 800 may determine whether the state of the system (or state of the shelf 803 or tray 809 in which item 831 is located) has changed since the cached image was cached. If system 800 determines that the change with respect to the state of the system, etc. is less than a threshold extent (e.g., a threshold value), then system 800 may determine the item to pick up (e.g., item 831) and/or a plan for picking up item 831 based at least in part on the cached image. System 800 may determine the item to pick up (e.g., item 831) and/or a plan for picking up item 831 based at least in part on the cached image and without generating a model (e.g., a complete image model) based on the current image and/or current information obtained by the sensors within the workspace. System 800 may thus use the cache image to determine the plan and/or in connection with picking up the item 831 without having to wait for camera 823 to stabilize or for current information obtained by the one or more sensors in system 800 to be processed to create a new image comprising at least item 831 and/or tray 809.

As illustrated in FIG. 8C, item 831 has been removed from tray 809. In some embodiments, in connection with picking a subsequent item, system 800 may use the cache image in connection with picking an item such as item 833 from tray 807 and/or item 835 from 811. System 800 may determine that the states of tray 807, tray 811, and/or the items within trays 807 and 811 has not changed. Accordingly, system 800 may use the cache image such as the image corresponding to the state illustrated in FIG. 8A. However, because item 811 has been removed from tray 809 by robotic arm 821, the cache image may not be sufficient to use for picking an item as illustrated in FIG. 8C. In some embodiments, even with item 811 having been removed from tray 809, system 800 may determine that a change in the state of tray 809 from before item 811 was picked and after item 811 was picked is not greater than a threshold value. In such a case, system 800 may use the cache image to determine a plan/strategy for picking an item from tray 809. Alternatively, in some embodiments, system 800 may determine that the change in state of tray 809 (e.g., as a result of item 811 having been removed) is greater than a threshold value, and in connection with picking an item from tray 809, system 800 may use a current image and/or current information pertaining to the workspace.

According to various embodiments, a kitting system may comprise a plurality of kitting shelf systems (e.g., kitting shelf machines). The plurality of kitting shelf systems may be operatively connected via a conveyance system. Related art systems generally only include a discrete robotic structure to which a receptacle is brought for a kitting of objects. The conveyance system of the kitting system may have an input end at which empty totes (e.g., receptacles such as bins, trays, etc.) are input to the conveyor which carries totes to the various kitting shelf systems comprised in kitting system. Robotic arms disposed at the various kitting shelf systems may pick items from the various kitting shelf systems and place the items in corresponding totes. As the totes are packed with one or more items, the conveyance structure may convey the totes to an output area of the kitting system. The output area may have a packing area or the totes may be removed from the conveyance structure and input to a packing system.

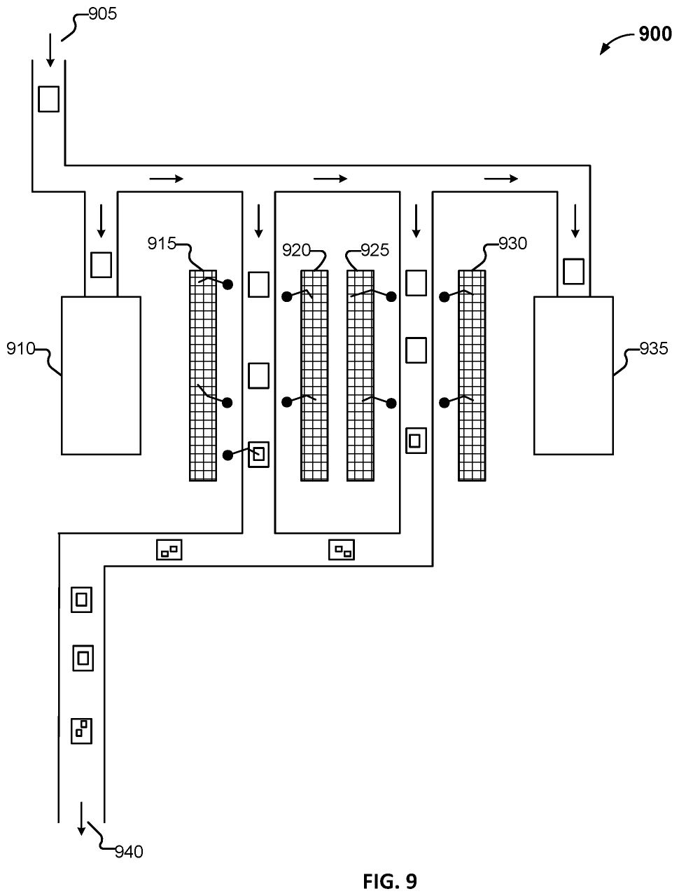

FIG. 9 is a diagram illustrating a kitting system according to various embodiments.

As illustrated in FIG. 9, kitting system 900 comprises a conveyance system that carries (e.g., distributes) totes to various kitting shelf machines. The totes may be input to the conveyance system at input area 905. Various ones of the totes are distributed to areas respectively corresponding to kitting shelf machine 910, kitting shelf machine 915, kitting shelf machine 920, kitting shelf machine 925, kitting shelf machine 930, and kitting shelf machine 935.

In some embodiments, conveyance structure terminates at a kitting shelf machine such as at kitting shelf machine 910 and/or kitting shelf machine 935 in kitting system 900. If the conveyance structure terminates at a kitting shelf machine, the totes that have been packed with one or more items (e.g., by kitting shelf machine 910 and/or kitting shelf machine 935) may be removed from the kitting shelf machine such as by a human operator (or otherwise manually removed) or from a different system.

In some embodiments, a plurality of kitting shelf machines are interconnected via the conveyance structure. For example, a plurality of kitting shelf machines may share a common input area at which totes (e.g., empty totes) are input to the kitting system. As another example, a plurality of kitting shelf machines may share a common output area at which totes (e.g., totes packed with one or more items) are output from the kitting system such as an area from where the totes are sent for packing, labelling, and/or other processing, etc. As another example, plurality of kitting shelf machines may share a common output area and a common input area. As illustrated in FIG. 9, kitting shelf machine 915, kitting shelf machine 920, kitting shelf machine 925, and kitting shelf machine 930 share a common input area 905 and a common output area 940. Accordingly, in the example shown n FIG. 9, kitting shelf machine 915, kitting shelf machine 920, kitting shelf machine 925, and kitting shelf machine 930 may be operatively connected by the conveyance structure. In some embodiments, a kitting shelf system may comprise a plurality of kitting shelf machines such as kitting shelf machines disposed on opposing sides of a conveyor. For example, referring to kitting system 900, a kitting shelf system may comprise kitting shelf machine 915 and kitting shelf machine 920; and another kitting shelf system may comprise kitting shelf machine 925 and kitting shelf machine 930. In some embodiments, each kitting shelf system may comprise a control computer(s) that controls a plurality of kitting shelf machines and corresponding robotic arms. In other embodiments, each kitting shelf machine may comprise its own control computer that controls the kitting shelf machine and corresponding robot. In other embodiments, kitting system 900 comprises a control computer that controls a plurality of kitting shelf systems and/or a plurality of kitting shelf machines.

In some embodiments, kitting system 900 may store and/or manage a data structure pertaining to an association of totes (e.g., trays) with orders or items. For example, a kitting shelf machine (or controller associated therewith) may reserve an empty tote for the kitting shelf machine to place items that a corresponding robotic arm has picked from the kitting shelf. As another example, in response to items being packed in a tote, the data structure may be updated to include a mapping of an identifier of the tote to an order for which the items are kitted and/or a mapping of an identifier of the tote to one or more items comprised in the tote.

Kitting system 900 may comprise one or more sensors and/or one or more arrays of sensors disposed along the conveyance structure. For example, the kitting system 900 may comprise one or more sensors at input area 905. As another example, the kitting system 900 may comprise one or more sensors at output area 940. As another example, the kitting system 900 may comprise sensors at areas along the conveyance structure where kitting machines are disposed. The sensors may be used in connection with associating totes with orders and/or items to be kitted (or that are kitted) within the totes. The sensors may also be used in connection with determining one or more attributes associated with the totes and/or items within the totes (e.g., obtaining an identifier on the identifier and/or an identifier on the one or more items, etc.).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A shelf system, comprising:
a feeder portion configured to receive a succession of items on a receiving end and convey the items to a destination end;
a presentation face configured to receive said items singly, each upon removal of a preceding item from the presentation face; and
a gate structure coupled to the presentation face in a manner such that the gate structure is placed in a closed position when an item is present on the presentation face, the closed position preventing item flow from the feeder portion to the presentation face, and such that the gate structure is placed in an open position when no item is present on the presentation face, wherein the open position allows a next item to flow from the feeder portion to the presentation face and the resulting presence of the next item on the presentation face causes the gate structure to return to the closed position.

2. The shelf system of claim 1, wherein the feeder portion is disposed at a position higher than the presentation face such that gravity at least partially causes an item to flow from the feeder portion to the presentation face when the gate structure is in the open position.

3. The shelf system of claim 1, wherein gate structure is biased to be configured in the open position when no item is present on the presentation face, and a weight of the item on the presentation face causes the gate structure to return to the closed position.

4. The shelf system of claim 3, wherein the gate structure is biased by one or more of a pneumatic module, a spring module, or an eccentric weight module.

5. The shelf system of claim 3, wherein the gate structure is integrated with the presentation face.

6. The shelf system of claim 1, wherein the gate structure is configured to retract or rotate from the closed position to the open position in response to removal of an item from the presentation face.

7. The shelf system of claim 1, wherein a weight of a next item on the feeder portion causes the gate structure to be placed in the closed position.

8. The shelf system of claim 1, wherein:
when an item is disposed on the presentation face an angle of the presentation face relative to a direction is different from an angle of the feeder portion relative to the direction; and
the direction along which the item moves from the feeder portion to the presentation face.

9. The shelf system of claim 1, wherein the items are bins that comprise one or more objects.

10. The shelf system of claim 9, wherein the one or more objects within a particular bin correspond to a homogeneous set of objects.

11. The shelf system of claim 9, wherein a robotic arm removes the bin from the presentation face in response to a determination that the bin is empty.

12. The shelf system of claim 1, wherein the presentation face is attached to the shelf system via a spring loaded hinge that returns the presentation face to an orientation according to which the presentation face is substantially parallel with the feeder portion.

13. The shelf system of claim 12, wherein when an item is present on the presentation face, the presentation face is moved to an orientation according to which the presentation face forms an acute angle relative to the feeder portion.

14. The shelf system of claim 1, wherein:
the presentation face is attached to the shelf system via a hinge, and when an item is present on the presentation face,
the presentation face is orientated at a predetermined angle.

15. The shelf system of claim 14, wherein the predetermined angle is an angle according to which the shelf system does not obstruct access of a robotic arm to the item on the presentation face or to an object comprised in the item.

16. The shelf system of claim 14, wherein the predetermined angle is an angle according to which the shelf system does not obstruct a line of sight of a camera disposed on the shelf system or a robotic arm with respect to the item on the presentation face or to an object comprised in the item.

17. The shelf system of claim 14, wherein the hinge is a dampened hinge configured to dampen movement of the presentation face an orientation of the presentation face when the gate structure is in the closed position.

18. The shelf system of claim 14, wherein the hinge connects the feeder portion and the presentation face.

19. A kitting system, comprising
a robotic arm; and
one or more shelf systems, each of the one or more the shelf systems comprising:
a feeder portion configured to receive a succession of items on a receiving end and convey the items to a destination end;
a presentation face configured to receive said items singly, each upon removal of a preceding item from the presentation face; and
a gate structure coupled to the presentation face in a manner such that the gate structure is placed in a closed position when an item is present on the presentation face, the closed position preventing item flow from the feeder portion to the presentation face, and such that the gate structure is placed in an open position when no item is present on the presentation face, wherein the open position allows a next item to flow from the feeder portion to the presentation face and the resulting presence of the next item on the presentation face causes the gate structure to return to the closed position.

20. The kitting system of claim 19, wherein:
the robotic arm is autonomously operated to pick and place one or more objects from an item on the one or more shelf systems to form a kit; and
the one or more objects picked that the robotic arm picks from the one or more shelf systems are respectively picked from the item on the presentation face of the corresponding shelf system.

21. The kitting system of claim 19, wherein in response to a determination that an item on the presentation face of a shelf system is empty, the robotic arm removes the item from the presentation face, and a next item on the corresponding feeder portion moves to the presentation face of the shelf system.

22. The kitting system of claim 19, wherein:
the robotic arm places the one or more objects in a predetermined location;
the predetermined location is a bin on a conveyance structure;
the robotic arm picks an empty item from the presentation face and places the empty item on the conveyance structure; and
the empty item is used as a bin for a kit of one or more objects picked and placed from the one or more shelf systems.

23. The kitting system of claim 19, wherein:
the kitting system comprises a plurality of shelf systems;
at least a subset of the plurality of shelf systems are vertically tiered with respect to each other; and
the subset of the plurality of shelf systems are staggered horizontally with respect to each other or the presentation faces of the subset of the plurality of shelf systems are oriented at different angles relative to their respective feeder portions when the presentation faces have an item disposed on the presentation faces.

24. The kitting system of claim 23, wherein a presentation face of a bottom shelf system of the subset of the plurality of shelf systems is not angled relative to a feeder portion corresponding to the bottom shelf system.

25. The kitting system of claim 24, wherein the bottom shelf system has a gate structure that is different from the gate structure of the other shelf systems in the subset of the plurality of shelf systems.

26. The kitting system of claim 23, wherein:
the robotic arm is autonomously operated to pick and place one or more objects from the one or more shelf systems to form a kit;
the one or more objects are placed in a bin on a conveyance structure; and
at least two of the plurality of shelves are disposed on opposing sides of the conveyance structure.

27. The kitting system of claim 19, further comprising a plurality of robotic arms, wherein:
the plurality of robotic arms pick a plurality of objects from the one or more shelf systems and place the plurality of objects in one or more bins on a conveyance structure.

28. The kitting system of claim 19, further comprising:
a plurality of sets of shelf systems,
wherein:
the robotic arm picks one or more objects from an item on the presentation face of at least one shelf system of at least one set of shelf systems;
the robotic arm places the one or more objects in one or more predetermined bins on a conveyance structure;
the plurality of sets of shelf systems are arranged such that:
each set of shelf systems has a shelf system disposed on opposing sides of the conveyance structure; and
a bin that moves along the on the conveyance structure passes more than one set of shelf systems before the bin exits the kitting system.

29. The kitting system of claim 28, comprising one or more rails disposed along a length of the conveyance structure.

30. The kitting system of claim 29, wherein each of the one or more rails has a plurality of robotic arms disposed thereon, and the plurality of robotic arms traverse the one or more rails to move within proximity of a selected set of shelf systems to pick an object from a presentation face of a shelf system in the selected set of shelf systems.

31. The kitting system of claim 29, wherein:
a first subset of the one or more rails is disposed on a first side of the conveyance structure;
a second subset of the one or more rails is disposed on a second side of the conveyance structure;
a first set of one or more robotic arms are disposed on the first rail and traverse the first rail to pick an object from a shelf system disposed on a first same side of the conveyance structure as the first rail; and
a second set of one or more robotic arms are disposed on the second rail and traverse the second rail to pick an object from a shelf system disposed on a second same side of the conveyance structure as the second rail.
